(19) United States
(12) Patent Application Publication
(10) Pub. No.: US 2014/0200944 A1
(43) Pub. Date: Jul. 17, 2014

(54) AUTOMATION OF MEETING SCHEDULING AND TASK LIST ACCESS PERMISSIONS WITHIN A MEETING SERIES

(71) Applicant: MatchWare A/S, Aarhus (DK)

(72) Inventors: Thomas B. Henriksen, Skanderborg (DK); Thomas Toftborg, Galten (DK); Adam Martingano, Indialantic, FL (US); Ulrik Merrild, Tampa, FL (US)

(73) Assignee: MatchWare A/S, Aarhus (DK)

(21) Appl. No.: 14/167,610

(22) Filed: Jan. 29, 2014

Related U.S. Application Data
(63) Continuation-in-part of application No. 14/135,933, filed on Dec. 20, 2013.
Application No. 14/135,933 is a continuation-in-part of application No. 14/081,550, filed on Nov. 15, 2013.
Application No. 14/081,550 is a continuation of application No. 13/291,099, filed on Nov. 8, 2011.

(51) Int. Cl. G06Q 10/10

(52) U.S. Cl. CPC G06Q 10/1095
USPC 705/7.19

(57) ABSTRACT

A computer software for managing electronic meetings. The meeting management system includes a Meeting Series feature. Individual meetings with at least one common characteristic may be grouped into a Meeting Series. The Meeting Series has a number of users/members associated with the entire Meeting Series and each individual meeting within the Meeting Series. Each meeting has a plurality of tasks associated with the meeting. The tasks are assigned to members. The members can access the task list for an individual meeting or the entire Meeting Series. The task list is dynamic and filtered based on the predefined permission rules. New meetings within the Meeting Series may be scheduled manually or automatically based on the status of the tasks associated with the Meeting Series. The list of members invited to each new meeting is prepopulated based on their membership within the Meeting Series and the status of the task assigned to them.

### RELATED APPLICATIONS

This application is a continuation-in-part of U.S. patent application Ser. No. 14/135,933, entitled “DETECTION AND RESCHEDULING OF UNADDRESSED TOPICS WITHIN THE MEETING MANAGEMENT SYSTEM,” filed on Dec. 20, 2013, which is a continuation-in-part of U.S. patent application Ser. No. 14/081,550, entitled “TOPIC DISTRIBUTION WITHIN A MEETING MANAGEMENT SYSTEM”, filed Nov. 15, 2013, which is a continuation of U.S. patent application Ser. No. 13/291,099, entitled “SYSTEM FOR COLLABORATION AND MEETING MANAGEMENT,” filed Nov. 8, 2011, the entire disclosures of which are herein incorporated by reference in their entirety.

### FIELD OF THE INVENTION

The field relates to an automated meeting management programs implemented on computer systems. More specifically it relates to automation of scheduling of new meetings and task list permissions within the series of related meetings.

### BACKGROUND

A mind map is a tool that consists of a diagram of words linked to and arranged around, sometimes randomly, a central topic. It is useful in the creative arts, project planning and collaborative decision making The tool is useful in visualizing, structuring and classifying ideas related to a central topic. Computer applications and systems have been devised to assist in the mechanics of the process of using a mind mapping tool, but generally, these systems do not change, substantially, the usefulness or results achieved using the tool compared to use of mechanical devices, such as a white board or butcher block pad.

In U.S. Pat. Pub. No. 2003/0233631, published Dec. 18, 2003, a mind map is shown in FIG. 4A. This mind map is used to define and capture the roles and scope of each role in a web-based application or business solution. This mind map is used to prepare specifications for a project to generate the web-based application. Four main branches are defined: contributor, user, editor and moderator. Each of these branches have additional branches that define the “I wants” of each of these four main branches.

In U.S. Pat. Pub. No. 2007/0190503, published Aug. 16, 2007, mind mapping is disclosed as a method of learning in which individuals use a process to recognize both the content and the structure of their own thinking This traditional mind mapping technique provides recursive expansion of thought processes, which identify the branches and structure in the thought processes of an individual, allowing the individual to examine his or her individual thinking and to discern how meaning is codified by an individual at a particular moment in time. This thinking about thinking is termed meta-cognition by the authors and is applied to individual learning and self-selection.

U.S. Pat. Pub. No. 2002/0049689, published Apr. 25, 2002, describes an example of a mind map in FIG. 3.2 that links words related to central ideas, with a certain number of links between central ideas. This publication teaches away from such unstructured hypertextual linking, without context, because the starting point concept keeps changing and the structure, itself, keeps changing with the hypertext movement. Furthermore, the mind map is flat, two-dimensional and rigid and does not acknowledge perspective of the viewer of the mind map. The traditional mind map, according to the publication, is woefully acontextual. Therefore, the process of selecting appropriate concept, building linkages and determining the content or knowledge inputs to be populated within each concept is not a well-defined process but is an art, requiring expert assistance. Instead, this publication proposes a sort of personalized search engine that provides links to topics of interest identified through an initial search.

Software sold under the ACCESS brand by Microsoft Corporation in Redmond, Washington is an example of a software program that operates on a computer system to allow a user to create a relational database. Microsoft Corporation also sells another software application under the VISIO brand which is an example of a software program that operates on a computer and allows mind mapping, presenting hierarchical bubble diagrams in a module referred to as brainstorming.

However, none of these issued patents or publications or any other known systems provides the tools and types of structures needed to collaboratively achieve desired goals as efficiently and effectively as disclosed herein. Indeed, the advantages of the examples disclosed are surprising and unexpected in this industry providing a synergistic system of tools and data structures that yields benefits in combination that are much greater than the sum of the individual components of the system including new features unavailable in known systems.

### SUMMARY OF THE INVENTION

A system for collaboration and meeting management comprises a computer, which may include one or more processors, memory storage devices, registers, database structures, input devices, output devices and the like, which may be centralized, distributed on a network or otherwise. A processor of the system receives instructions stored in a memory location of the system and accesses data from a memory storage device or devices. The data may be stored in a database structure, such as a relational database, for example. The architecture of the computer is well known and may include virtual processors and virtual storage distributed on more than one computer system and more than one storage medium.

Based on this written description, a person having ordinary skill in the art of computer programming, using available programming tools, may implement a system including the features of the examples disclosed without undue experimentation. Object oriented, graphical software tools allow such a person to generate the screens displayed in the examples, and database programming tools allow such a person to generate the necessary database structures. Nevertheless, the implementation of interoperable features disclosed in the examples is new and nonobvious over known systems, when implemented in the system arrangements described and claimed.

Anyone or more of several available programming languages may be used to implement examples of the system in conjunction with objected oriented design principles and database structures, such as C++, scripting languages, relational databases and existing programming environments. The software development of the various screen shots and flow diagrams is within the skill of a team of programmers having ordinary skill in the art of software development. Any of a variety of database solutions may be included in implementing a system as are very well known in the industry, such as relational database programming libraries and environments for defining and controlling a database structure capable of storing and sharing data from the database as disclosed herein.

For example, a mind mapping system according to one example provides a structured system for collaborative project planning and plan execution. A mind mapping system may implement a method for creating, distributing and tracking task and process information. In one example, the system includes a mind mapping system, and the mind mapping system is capable of creating a mind map. Known mind maps include at least one core idea and branches extending from the core idea.

In one example, each branch is assigned a unique identifier (Branch ID), and each branch may correspond to and define a task or tasks, together with the requirements necessary to complete such task or tasks. Each branch may relate to additional branches that extend from the task or tasks defined by the Branch ID, and these child branches are assigned unique identifiers, which may be referenced to the Branch ID of the parent branch, for example.

A task in a project management mind mapping system may be defined as an individual classifying topic, for example, which may be created to describe activities deemed necessary to complete project requirements.

An organizer of the project may be allowed to control the mind mapping system, or the system may allow the organizer and others to cooperatively control all or portions of the mind mapping system. A computer interface is provided that is capable of control of the mind mapping system by a user interacting with the input/output devices of the computer.

For example, the organizer may be allowed to convert each Branch ID into a task. The task may be defined by the organizer by certain parameters. These parameters may include task scheduling and distribution values, such as duration, start date, end date, priority, completion and allocated resources. These values may be visually displayed in a branched, hypertextual mind map accessible by those selected to have access to specific ones of the Branch ID's, for example. Access may be provided to read and/or change all or portions of the information in a particular Branch ID or Branch ID's.

In one example, the system allows the organizer to export and/or integrate the structure of the branched, hypertextual mind map into an external project management or task tracking system. For example, the system exports tasks to the task tracking systems of MICROSOFT OUTLOOK or LOTUS NOTES, populating these popular calendaring and scheduling systems with tasks and values for individuals that are assigned to specific Branch ID's, for example, transforming these popular calendaring and scheduling systems into distributed project management tools. It is known in the art how to export task scheduling to such popular calendaring and scheduling systems. Examples are provided in software development kits and by the purveyors of the popular calendaring and scheduling systems.

Microsoft Corporation publishes online instructions on how to interference with the OUTLOOK automation in Microsoft Support Article ID: 220600, which is incorporated herein by reference.

In one example, the organizer defines a resource task list, identifying electronic identifiers, such as unique email addresses, of human resources assigned to a specific Branch ID. For example, the organizer is permitted to distribute tasks to individuals using the unique email address assigned to the individual, based on the resources allocated by the organizer to a specific Branch ID in the mind mapping system. The external task tracking system is updated with the respective values assigned as parameters by the organizer in the mind mapping system.

In one example, an individual receiving such information may be authorized to change some or all of the values in the external task tracking system, such as duration, start date, end date, priority, completion and resources, and feedback will be provided to the system of mind mapping. For example, the system of mind mapping may update the system with the changes made by an individual in the external task tracking system and may automatically update other values in the system of mind mapping to accommodate the changes by the individual in their own task tracking system. For example, the values, such as duration, start date, end date, priority and resources, of a Branch ID and/or a child of a Branch ID and/or a parent of a Branch ID may be updated by the system of mind mapping, automatically, when an individual updates values related to a different Branch ID or a parent or child of a Branch ID. The system of mind mapping may automatically export these new values according to the allocated resources entered into the mind mapping system. These values may be modified by receiving individuals, who are permitted to change the values, in their particular task tracking system, which may recursively update the mind mapping system, automatically adjusting and updating the external task tracking systems of the individuals allocated as resources by the mind mapping system.

In one system, each individual allocated as a resource in a unique Branch ID accesses an external task tracking system on a computer. The external task tracking system may be any of the popular systems available from third parties. The mind mapping system may reside on an organizer's computer, server or through a third party website providing software as a service. The mind mapping system may operate according to the rules of one of the known mind mapping utilities that permits structuring of projects by mind mapping techniques, such as MINDVIEW™. For example, this permits distributed, cloud task scheduling and synchronization using resources available to users using popular calendaring and scheduling software.

In one example, certain of the Branch ID's may be locked by the organizer By locking the Branch ID, the organizer can prevent the values entered by the organizer in the Branch ID from being changed by individuals allocated as resources in the locked Branch ID or other Branch ID's. Alternatively, only certain values in a Branch ID may be locked to prevent automatic changing of the values. In either alternative, an attempted change of locked values or values of a locked Branch ID may generate an email from an individual allocated as a resource by an organizer, and an email may be generated by the system of mind mapping, automatically, informing the individual that the value is locked and changing the value back to the locked value. Feedback may be given to the organizer of the attempt to change locked parameters and the nature of the change to the value that was attempted by one of the individuals allocated as a resource. In this way, the organizer may become aware of an issue that needs to be addressed, while positively controlling a project being managed by the system of mind mapping.

In one example, the organizer may assign particular individuals to be able to change particular values in a Branch ID. For example, an individual may be able assigned permission to update values in one Branch ID, but may be restricted from causing changes in values in one or more locked Branch ID's. For example, any changes made in a Branch ID by an individual, in which the individual is allocated as a resource in the Branch ID and is given I permission to make any changes, may generate an email that returns the changes to the mind mapping system. The mind mapping system may determine if the individual is permitted to make the changes, will automatically check the values to see if the change affects only one Branch ID or will affect other Branch ID's, necessarily or permissively, and will determine if the individual has permission to change values in the other Branch ID's. If permitted, then the change may be made automatically by the system of mind mapping. If not permitted or if the change would affect, necessarily, the values of a locked Branch ID, to which the individual is not granted permissions, then the change may be rejected by the mind mapping system. For example, an individual may be permitted to indicate when a task associated with a unique Branch ID is completed, and this may be updated in the mind mapping system, but the same individual may not be permitted to change the end date or deadline set in the mind mapping system.

In one example, as only the organizer has access to and control over the mind mapping system, the system of mind mapping provides a secure, distributed task scheduling and control environment. In one example, the mind mapping system may push values to distributed individuals identified as allocated resources in one of the Branch ID's from time to time, ensuring that external task tracking software of the individual is current and is receiving email from the mind mapping system.

In one example, the system utilizes a shared workspace, which is an online system created to host and share interactive document files. For example a shared workspace may include one or more online systems, such as MICROSOFT SHAREPOINT, MICROSOFT LIVE, or GOOGLE DOCS for sharing interactive files, such as MATCHWARE MINDVIEW files, MICROSOFT OFFICE files, ADOBE ACROBAT, GOOGLE DOCS files: and the like. Information about a task may be updated in a resource's task view, within a shared workspace or within distributed mind mapping systems operating on remote processors, and both the shared workspace and the distributed mind mapping systems may be updated by synchronization, for example. In this example, individuals given permission to certain Branch ID's may update parameters associated with the permitted Branch ID's but may be prevented from updating parameters in certain locked Branch ID's. Using a shared workspace reduces the overhead and may reduce errors associated with email distribution of changes to values made by individuals. Using the shared workspace, the individuals allocated as resources in the mind map system still may be sent email that updates their local task scheduling software, for example, but collaboration on documents and changes to the values in a Branch ID would be made in the shared workspace or synchronized by the shared workspace. The notification email may provide a link to a resource that the resource may click on to access a mind map document in the shared workspace. The originator may be provided control over who has read and/or write access to the document or to particular branches in the document and when the access is provided. The system may provide write access to one or more resources during a collaborative editing of a mind map document accessed by a plurality of individuals in a common shared workspace, for example.

The system may include a meeting management system, which may be resident on a server coupled with a database and an application, for example. In one example, a method for collaboration and meeting management uses the system. The system may comprise the steps of implementing a mind mapping method comprising creating a visual mind map of a plurality of branches of a mind map generated in the mind mapping system; assigning a unique identifier for each branch of the plurality of branches, extending one or more child branches from each branch in the visual mind map, and assigning a unique child identifier to each of the one or more child branches, such that the unique child identifier includes a reference to the unique identifier of the branch from which the child branch is extending; allowing input from an organizer of a project to control the mind mapping system, such that the mind mapping method converts each unique identifier into a task of the project, and storing a plurality of parameters in a database such that the plurality of parameters include a value for task scheduling and a value for task distribution to at least one allocated resource; visually displaying a branched, hypertextual mind map on an output device, and permitting the at least one allocated resource to change one of the plurality of parameters arranged in the database structure based on the value for task distribution; providing a shared workspace for collaborative mind mapping of each of the tasks; and exporting each of the tasks to an external project management or task tracking system of the at least one allocated resource, according to the value for task distribution and data contained in the value for scheduling, such that the data is received by the external project management or task tracking system in a format compatible with the external project management or task tracking system.

In one example, the method further comprises receiving changes from the external project management or task tracking system of the at least one allocated resource, when changes are made in the external project management or task tracking system by any of the at least one resource within the external project management or task tracking structure, and/or processing the changes received in the step of receiving by checking the value for task distribution and determining if the value for task distribution permits the at least one allocated resource to make the changes received in the step of receiving changes. For example, a step of processing the changes may include preventing the change and informing the at least one resource that the value is locked, when the at least one resource is not permitted to make changes to the value or values according to the value for distribution. A method may further comprise returning the value or values changed in the external project management or task tracking system back to the unchanged value or values, when the at least one resource is not permitted to make the changes to the value or values according to one or more of the values for distribution, for example. For example, a step of notifying the organizer of an attempt to change parameters may be included if the value for task distribution permits the at least one allocated resource to make the changes received in the step of receiving changes. The step of notifying may include describing the nature of the change to the parameters that was attempted in order to inform the organizer of an issue raised by one of the assigned resources.

In one example, particular ones of the at least one resources are permitted to make changes to particular ones of the plurality of parameters. The step of permitting particular ones may allow different changes by the at least one allocated resource in the shared workspace for collaborative mind mapping than the changes allowed in the external project management or task tracking system, for example. In this way, the collaborative process in a shared workspace may be more fluid than the automated process in a distributed system utilizing external project management or task tracking systems, which may require additional controls to prevent unauthorized changes from occurring without careful scrutiny by the supervisor of the overall project. Controls may be implemented to allow only one or a few trusted individuals to make changes to some of the project parameters identified in the system.

In one example, the system may receive an email from the external project management or task tracking system whenever a resource makes a change in one or more of the plurality of parameters within the external project management or task scheduling system. Then the system may include a step of determining if the resource is permitted to make the particular change to the particular parameter, such as the value for task scheduling, for example. The step of determining may include automatically checking the particular one of the values for scheduling to determine if the change affects only one task identified by a unique identifier or will affect other tasks, and may determine if the at least one resource has permission to change the other tasks, when the change will affect other tasks, and permitting the change to the value for scheduling only when the step of determining determines that the at least one resource has permission to change both the value of scheduling for the task identified by the unique identifier or unique child identifier and the value of scheduling for any other tasks.

A method may further comprise a step of rejecting any change made when the step of determining values determines that the change will affect other tasks and the particular resource is not permitted by default rules or rules entered by the organizer to make changes to tasks in one or more of the other tasks that would be impacted by the change made by the resource. The change may be rejected if the change would alter, necessarily, a secondary value in a branch associated with a unique identifier or unique child identifier to which the at least one resource making the change is not granted permissions to change the secondary value, for example. For example, a value relating to task completion may be entered by the resource, such as an entry showing that one or more task or sub-tasks have been completed. If authorized in the system to update the value related to task completion, the system may automatically update both the completion status and a start time for another task that is dependent on the value relating to task completion entered by the authorized resource.

A method of meeting management may be implemented within a system of collaboration and meeting management. For example, the method of meeting management comprises creating a meeting agenda in the mind mapping system by implementing a mind mapping method for generating a plurality of topics as branches in the mind mapping system, and assigning the unique identifier to the branches and the unique child identifier to sub-topics within each of the plurality of topics, if any, and saving the meeting agenda in the database. The step of creating may provide for inputting of a title, a start time and a duration for each of the plurality of topics, such that if the title, the start time and the duration are input for any of the plurality of topics. The value for task scheduling for the particular one of the plurality of topics may include any of the title, the start time and the duration for each of the plurality of topics input in the step of creating and for sub-topics or portions of topics and the like. Topics may include fixed start times, end times or durations, for example, and may be allowed to be split or may not be allowed to be split. In one example, a default rule is provided that allows topics to be split at sub-topics, unless a rule is established for the topic or for the particular sub-topic or sub-topics preventing splitting of the sub-topic or sub-topics. Splitting of sub-topics from non-fixed topics may be used by the system to automatically fill gaps between fixed start or end times of topics, for example. Alternatively, duration of non-fixed or fixed topics may be extended or decreased to fit topics within the length of an agenda, or the system may provide a notification of a problem with the number and duration of topics or the time allocated for the meeting agenda, if topics cannot be fit into the agenda.

A meeting editing system may be displayed in either mind map or agenda mode allowing amending of the title, the start time or the duration for any of the plurality of topics, including adding or changing information related to any sub-topics within each of the plurality of topics. Alternatively, a step of a method may first check automatically to see if there is time available in the schedule for filling a time gap between a meeting start time and a first fixed topic, and may insert a break between the meeting start time and the topic start time if there is sufficient time in the schedule, before determining if a topic or portion thereof, such as a sub-topic, should be moved to fill the time gap, for example, or may first check to see if a non-fixed topic or sub-topic fits in the particular time gap before entering a break. Default and custom rules may be adopted to define the preferences and order of steps in the method, for example. Also, the system may move the start time of the meeting, if allowed, to correspond to the first fixed topic, if the organizer requires the first fixed topic to be the first topic in the meeting agenda. Likewise, a time gap might exist between two fixed topics, which start times, durations or end times may be fixed by the organizer or during a mind mapping exercise or later during editing of an agenda, based on availability of resources, for example. Then, the system may automatically check to see if there is time available in the meeting agenda schedule to allow the gap to be filled out as a break or if it is necessary to move one or more non-fixed topics or portions thereof, if permitted, to fill all or a portion of the time gap between two fixed topics. In this way, the system may automatically optimize the meeting agenda prior to any need to manually adjust the number of topics and parameters of topics in the meeting agenda.

For example, the system may automatically distribute topics within an agenda based on rules within a system for distributing topics. The step of distributing topics may include calculating if the duration of one or more of the topics is greater than a time allocated for a meeting agenda, and prompting a user to make a change to the length of one or more of the topics, the time allocated for the meeting agenda or removing one or more of the topics from the view of the mind map or a view of the agenda, for example. If the step of calculating calculates that the duration of all of the topics is less than the time allocated for the meeting agenda, then the system may determine the remaining time of the meeting agenda not allocated to one or more of the topics, before determining if the remaining time is to be allocated automatically based on default rules or rules established by the organizer or others authorized to set such rules for the system. For example, if the remaining time is to be allocated automatically, then the system may automatically add time to particular ones of the plurality of topics based on the rules, such adding time equally to each of the topics or adding time proportionally to each of the topics based on the duration assigned to each of the topics. In one example, a topic with no assigned duration in the value for task scheduling may not have any time added during this first pass.

In one example, the meeting agenda may be adjusted by the system. For example, the step of adjusting the meeting agenda may include first sorting fixed topics having a fixed start time from non-fixed topics having no fixed start time, wherein the fixed topics may be sorted in order according to fixed start time from the earliest fixed start time to the latest fixed start time, for example. Then, if any non-fixed topics overlap any fixed topics, the system may determine if the non-fixed topics may be split based on the rules (or alternatively if extra time remains for inserting breaks). Splitting those non-fixed topics that may be split based on the rules and moving the non-fixed topics or split portions thereof to start after an end time of one of the fixed topics may be used to optimize the meeting agenda, using the time most efficiently. However, the system may contain rules about inserting breaks at certain minimum and maximum rules that may give a preference to inserting a break, as a “topic,” rather than inserting a topic or a portion thereof in a time gap.

In one example, the method may include comparing a start time assigned to a first topic of the plurality of topics in the meeting agenda and a start time for the meeting, and if the start time assigned to the first topic begins after the start time for the meeting, then if the start time assigned to the first topic may be changed to the meeting start time, changing the start time assigned to the first topic to the meeting start time. Alternatively, the meeting start time may first be changed to the start time of the first topic, if the meeting start time is allowed to be changed and the rules allow for first adjusting the meeting start time. If not, then if the duration between the meeting start time and the start time assigned to the first topic is sufficient to insert a non-fixed topic or portion thereof, if the non-fixed topic may be split based on the rules, then a method may change the start time of one of the non-fixed topics or portion thereof In this case, the time gap is filled with a non-fixed topic or portion thereof, such as a sub-topic, having a duration equal to or less than the duration between the meeting start time and the start time assigned to the first topic, for example. Otherwise, a break may be inserted between the meeting start time and the start time of the first topic and/or an alert or notification message may be displayed to notify of the lack of an automated solution for the time gap based on the rules used by the system.

For example, a step of adjusting the meeting agenda may include, if a time gap exists between an end time of anyone topic and the start time of another topic, such as two adjacent fixed topics in a sequentially sorted list of fixed topics, and if the start time of the later topic may be changed based on the rules, then the method may change the start time of the later topic to begin earlier, when the duration of the first topic ends. Herein, it is understood that “when the duration of the first topic ends” includes any rule-based break required between topics by the system. For example, the system might require a one minute, five minute or ten minute break between topics or sub-topics. Alternatively” the system may not require any break between topics or may require a break of a particular duration whenever a maximum break-free duration is exceeded, such as every four hours, for example. Likewise, the system may require no breaks until a minimum break-free duration is exceeded, such as thirty minutes, for example.

If the start time of a topic may not be changed based on the rules, then if the duration between the end time of the one topic and the start time assigned to another topic is sufficient to insert a non-fixed topic or portion thereof, if splitting is allowed, then the method may change the start time of one of the non-fixed topics or portion thereof, if it has a duration equal to or less than the time gap between the end time of the first topic and the start time assigned to next topic. The non-fixed topic may be added to the end time of the first topic, for example, such that the time gap is filled or partially filled by the non-fixed topic. Otherwise, a break may be inserted between the first topic and the next topic following the first topic, for example. Each of the time gaps between one fixed topic and the following fixed topic may be filled with either a break or a non-fixed topic during this agenda optimization process, for example, by adjusting the start and end times of non-fixed topics or portions thereof, such as sub-topics, or by inserting breaks. The rules of the system may be adjusted to either first select breaks, if time is available for more breaks in the meeting agenda, or to first select non-fixed topics to fill the time gaps. In one example, breaks are first inserted and then the system allows the meeting agenda to be adjusted manually. In another example, the system is allowed to optimize the meeting structure by filling time gaps with topics and sub-topics first, if non-fixed topics or subtopics are provided without fixed start times and durations or end times.

In one example, the step of adjusting extends the duration of the non-fixed topic to end at the start time for the fixed topic, if a time gap exists between a non-fixed topic and a subsequent fixed topic and if extending the duration of the non-fixed topic to end at the start time for the fixed topic is permitted. Otherwise, if there is time available in the meeting agenda for filling out the time gap, a break is inserted between the non-fixed topic and the subsequent fixed topic. If there is not time available in the meeting agenda for filling out the gap, then the system may take a topic of another of the non-fixed topics or portion thereof, if another of the non-fixed topics may be split based on the rules. For example, the method may change the start time of a topic or sub-topic having a duration equal to or less than the duration between the end time of the non-fixed topic and the start time of the subsequent fixed topic, for example, such that the start time coincides with the end of the previous non-fixed topic. This way, the meeting agenda may be optimized for covering as many topics as possible within a set time period for a meeting agenda, for example.

If any non-fixed topics have no value for duration specified, then if there is remaining time of the meeting agenda not allocated to one or more of the topics, the method may distribute the remaining time among the non-fixed topics with no value for duration specified, for example. If there is no remaining time of the meeting agenda not allocated to one or more topics and any non-fixed topics have no value for duration specified, then if sufficient time may be taken from other non-fixed topics having a specified duration, based on the rules of the system, then the method may release from the other non-fixed topics having a duration specified the time needed to schedule non-fixed topics having no duration specified. This released time may be allocated among the non-fixed topics having no duration specified. If sufficient time is not available from only other non-fixed topics, then the system may release time from the fixed topics, if any fixed topics have time that may be released based on the rules. The time released from fixed topics may be allocated among the non-fixed topics having no duration specified, based on rules of the system, such as equally among topics, for example. Otherwise, if sufficient time is not available from the non-fixed topics and the fixed topics, then the method may provide an alert or notice that there is insufficient time for all of the topics to be scheduled. This notice informs the organizer or responsible resource that edits to the meeting agenda are necessary before completing the final meeting agenda. For example, one or more topics may need to be parked and/or the duration of topics or the meeting agenda may need to be altered.

In one example, optimizing of the meeting agenda occurs after the meeting agenda has been created or edited, and an automatically generated dashboard chart may include information relating to the meeting agenda, the plurality of tasks, conduct of a meeting using the meeting agenda and feedback obtained after conduct of the meeting. The system may provide the organizer and other users a dashboard chart display, for example. The method may comprise conducting a meeting using the meeting agenda, and capturing data on the conduct of the meeting during the meeting.

In one example, the method includes parking a topic or sub-topic. For example, during a meeting, an organizer may select a particular topic and may have an option of parking the particular topic, such that information related to the topic is flagged as saved in a parking lot or is saved in a database flagged as a parking lot database. This allows the particular topic to be skipped, for example, due to time constraints, missing participants or lack of data necessary for discussion of the topic. Then, the system may make the topic or a sub-topic available during creation of a new meeting agenda or during editing of a different saved meeting agenda, such as by selecting the parked topic from a mind map, list, database or the like. Likewise, a topic may be saved after completion of a meeting, such that the topic and its information is flagged as a past meeting topic or is saved in a database flagged as a past meeting database, wherein the topic or portion thereof is available during creation of a new meeting agenda or during editing of a different saved meeting agenda.

The system may provide detailed analysis of data captured during meeting planning, conduct of the meeting and feedback following the meeting, together with task data and user data. For example, the system may include a rating or review of the efficiency of an organizer or responsible person, which may be used in determining compensation, such as salary and bonuses, promotions and other personnel decisions, based on reviews of efficiency and effectiveness.

Topics visualized in a mind map and/or agenda may include color schemes, icons or other types of details to show relationships between topics, for example. Each mind map contains a root and at least one main branch and optionally additional branches and/or sub-branches. These branches and/or sub-branches may be mapped as topics and/or sub-topics of a meeting agenda.

Other combinations and variations of the mind mapping system and advantages of the mind mapping system will be apparent from the drawings and detailed description.

### BRIEF DESCRIPTION OF THE DRAWINGS

FIG. 1 illustrates an example of the use of a shared workspace by multiple users.

FIG. 2 illustrates an example of a flow chart for determining what level of access a user has to the shared workspace.

FIG. 3 illustrates an example of branch locking by an organizer.

FIG. 4 illustrates an example of branch locking by a user other than the organizer, showing a locked branch.

FIG. 5 illustrates an example of a flow chart for providing read and write access privileges to documents in a shared workspace with branch locking.

FIG. 6 illustrates an example of creating a mind map and distributing tasks using a shared workspace.

FIG. 7 illustrates an example of information entry into a task management mind map for a 2nd issue.

FIG. 8 illustrates an example of adding resources to a particular Branch ID for the 2nd issue of FIG. 7.

FIG. 9 illustrates an example of the interface for actuating distribution of the tasks from the shared workspace.

FIG. 10 illustrates an example of an email notification to a resource listed in the examples of FIGS. 7-9.

FIG. 11 illustrates an example of the tasks tab accessed by a resource in shared workspace, listing tasks assigned to the resource.

FIG. 12 illustrates an example of an interface to import tasks from resources.

FIG. 13 illustrates another example of a flow chart for distributing tasks using MICROSOFT OUTLOOK, for example.

FIG. 14 illustrates an example of an interface for exporting and synchronizing tasks in OUTLOOK®.

FIG. 15 illustrates an example of check boxes for including or excluding certain information from being exported to OUTLOOK.

FIG. 16 illustrates an interface for synchronizing the mind mapping system and OUTLOOK.

FIGS. 17 A-B show an example of A) a mind map and B) a meeting agenda generated from the mind map.

FIG. 18 illustrates an example of a tool for specifying rules for rounding and splitting of topics.

FIG. 19 illustrates an example of a break distribution tool for specifying rules for breaks.

FIG. 20 illustrates another example of a screen shot during adjusting of a meeting agenda including scheduling tool for specifying the start and end of the meeting agenda, number and duration of breaks, and start times and end times of breaks, such as breakfast, lunch and dinner.

FIG. 21 illustrates an example of a template tool for formatting an agenda.

FIG. 22 illustrates an example of a screen shot showing an agenda wizard tool for adjusting the number of topics and breaks during a meeting agenda.

FIG. 23 illustrates an example of a screen shot showing meeting notes being entered for a current topic.

FIG. 24 illustrates an example of a screen shot showing the Meeting Performance Dashboard.

FIG. 25 illustrates an example of a screen shot showing an ongoing meeting and a Parking Lot button.

FIG. 26 illustrates an example of a screen shot showing a subject-based template, which may be selected to create a new agenda.

FIG. 27 illustrates an example of a flow chart for a time distributor system for automatically creating and editing a meeting agenda including examples of a flow diagram including a time distributor and topic adjusting systems.

FIG. 28 illustrates an example of a flow chart for the time distribution system, showing an example for rules that distribute time on non-fixed topics, and if there are non-fixed topics without duration specified and no remaining time exists in the meeting agenda, then time is collected from topics with specified durations and is distributed to topics without specified durations, for example.

FIG. 29 illustrates an example of a topic adjusting system allowing adjusting of a meeting agenda based on rules, such as fixed topics are sequenced in order from first start time to last start time, no topics are allowed to overlap and no gaps are allowed between topics and meeting start time, for example.

FIG. 30 illustrates an example of data storage and display for a meeting dashboard capable of organizing and displaying statistical data relevant to the system and method of collaboration and meeting management, for example.

FIG. 31 illustrates an example of parking and saving topics for later use in generating a later meeting agenda, for example.

FIG. 32 is flowchart schematically illustrating the method of classifying a topic as addressed or unaddressed.

FIG. 33 is a screenshot illustrating an exemplary electronic meeting agenda.

FIG. 34 is a screenshot illustrating an exemplary electronic meeting agenda showing an active topic

FIG. 35 is a screenshot illustrating an ongoing active topic with a set of corresponding notes including a conclusion statement.

FIG. 36 is a screenshot of a GUI dialogue window showing the list of unaddressed topic and presenting the user with an option to select topics for a follow-up meeting.

FIG. 37 is a screenshot of the Details tab for a follow-up electronic meeting agenda.

FIG. 38 is a screenshot of a dialogue box presenting the user with an option to merge the meeting minutes for the original and follow-up meetings.

FIG. 39 is a dialogue window for creating a new meeting and/or new Meeting Series.

FIG. 40 is a flowchart illustrating the steps for creating and filtering a task list according to the predefined permission rules.

FIG. 41 is a flowchart illustrating the steps for filtering the task list for the Meeting Series to exclude all tasks not associate with a specific single meeting.

FIG. 42 is a GUI window having a first tab for displaying the Meeting Series task list and a second tab for displaying task for a single meeting.

FIG. 43A is a GUI window showing all Meeting Series of which the user is a member.

FIG. 43B is a GUI window showing a list of the meetings the user was a part of

FIG. 44A is a GUI window showing a listing of all meetings that belong to the Meetings Series under the Meetings tab of the window.

FIG. 44B is a GUI window showing a running task list for the Meeting Series under the Tasks tab of the window.

FIG. 44C is a GUI window showing all members of the Meeting Series under the Members tab of the window.

FIG. 45 is flowchart illustrating the steps for creating a new meeting within the Meeting Series and automatically prepopulating the attendee list.

FIG. 46 is flowchart illustrating a set of predetermined permission rules used to determine which task to include on the task list for a user.

### DETAILED DESCRIPTION OF THE DRAWINGS

The drawings and detailed description show examples and should not be used to limit the claims that issue.

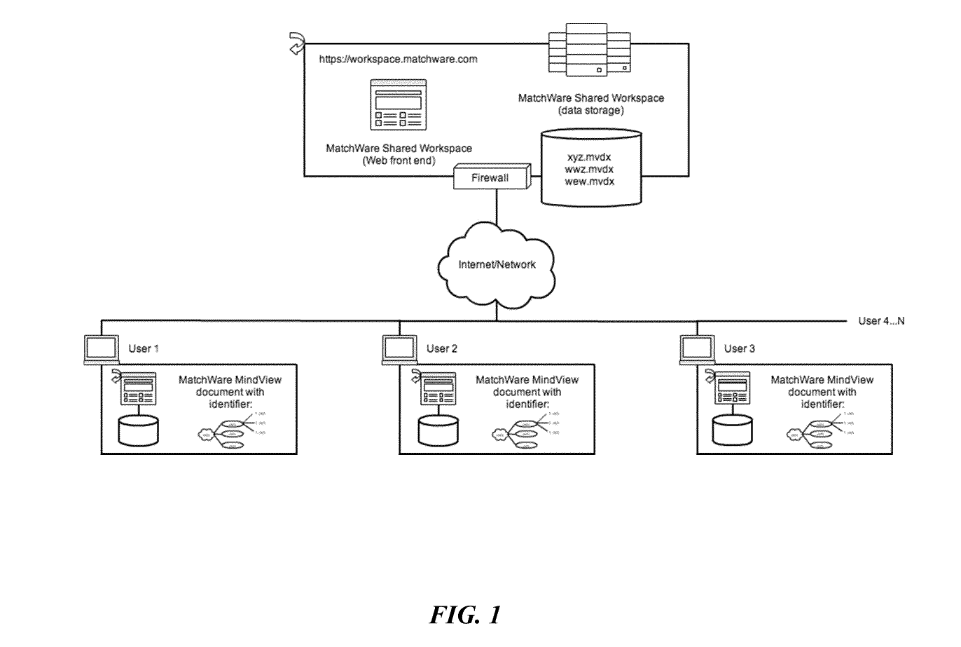

In FIG. 1, shows a plurality of users accessing a shared workspace over the internet or a computer network. Each of the users accesses the shared workspace using a computer system or work station that is electronically coupled by a network to one or more servers hosting the shared workspace. The shared workspace is stored in one or more databases stored on one or more storage media accessible by the users through the shared workspace. In one example, the shared workspace comprises a set of internet-based services designed for customers and/or businesses interested in storing and sharing documents, accessible online by multiple users. In one example, one of the known services providers are used host the shared workspace. Any document located in the shared workspace is able to be shared among a plurality of users. In one example, a mind mapping document is shared between users, which can be shared for real time collaboration, the mind mapping document being shared by a plurality of users, simultaneously, in a collaborative editing of the mind mapping document, for example. A shared workspace is used as a platform for hosting a collaborative mind map, as part of a mind mapping system comprising at least one server, at least one storage medium coupled to the server, and a plurality of users coupled to the at least one server over a network, such as the Internet or an intranet. The entries or edits made by the plurality of the users are immediately distributed via the shared workspace to every other user accessing the same document, synchronizing the document in real time.

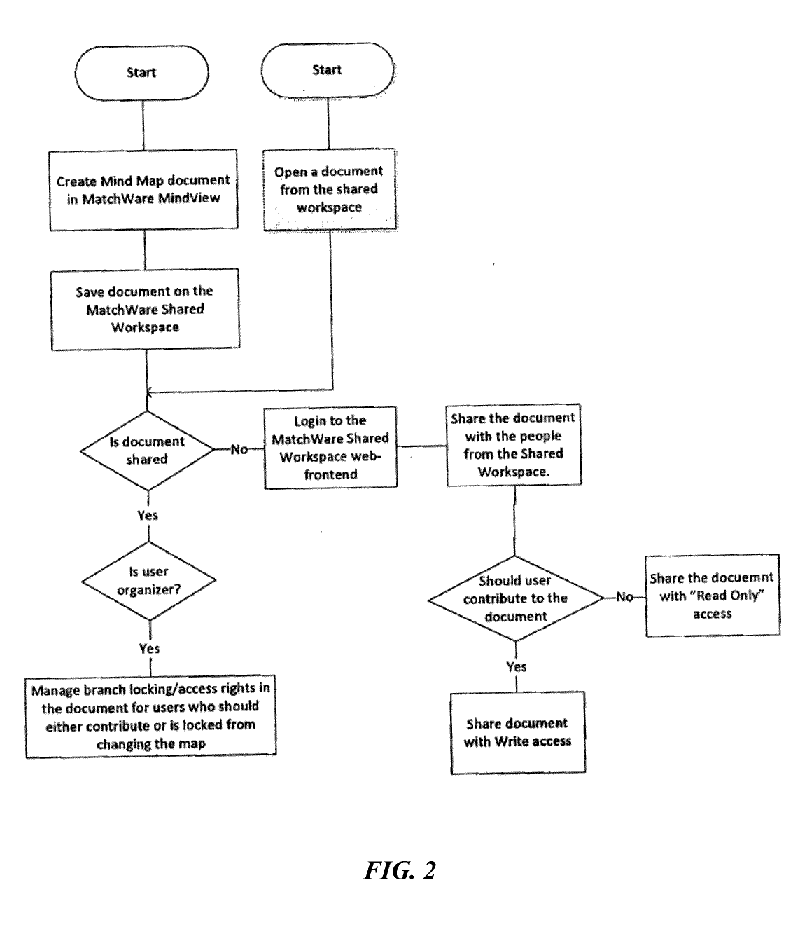

Documents, such as a mind map documents, that are shared in the shared workspace 100 may be set up by an organizer for viewing (read only access) or for editing (read/write access) by one or more individuals. In one example, the mind mapping system provides limited write access to one or more resources, i.e. individuals designated by the organizer as resources in a resource list associated with a mind map, by locking certain branches to editing by any of the one or more resources. For example, a resource may be granted permissions to access certain branches or may be denied access to certain branches, using a unique Branch ID or using a graphical interface. In one example, the default setting is for every resource listed in a resource listing by an organizer to have open access, i.e. write access, to edit an entire mind map document, and the organizer must specify if certain branches within a mind map are to be locked. FIG. 2 illustrates a flow chart showing how the type of access to a mind map is determined during access to a mind map. If the user accessing the document is the organizer, then complete access is granted including the ability to manage branch locking and access rights to locked branches. Users other than the organizer mayor may not have access to all of the branches of a mind map document. A user may be denied access to a document if the user does not have a valid user identification and password, for example. If the user successfully logs into the shared workspace, then the mind map system determines if the user is granted read-only or write access within the document.

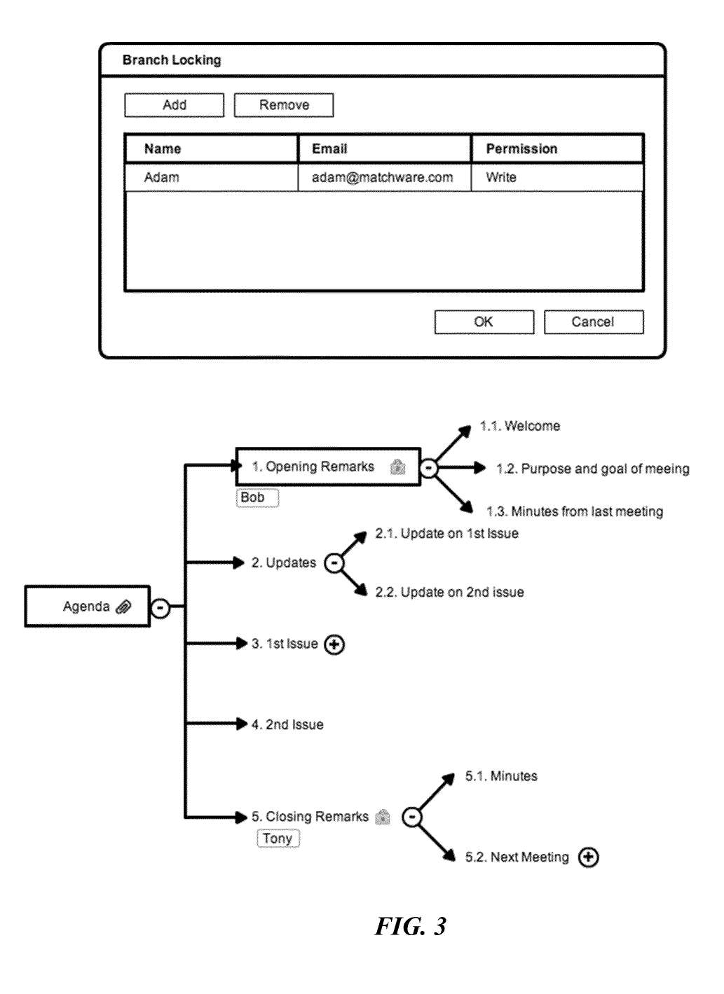

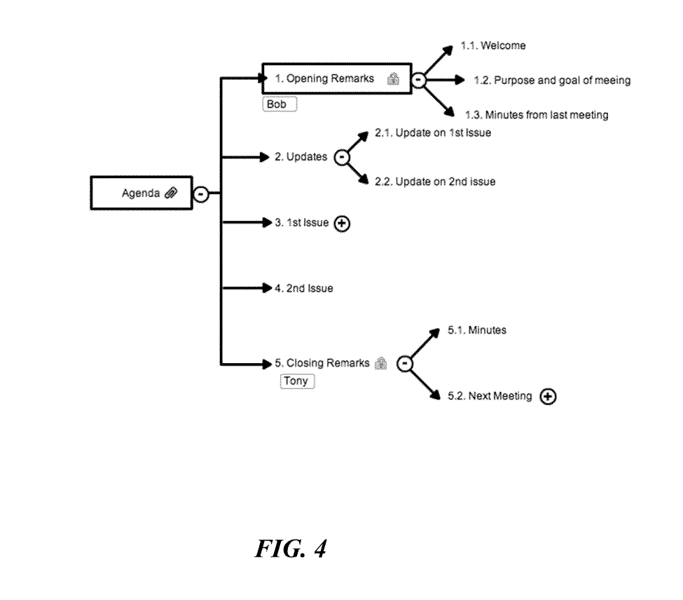

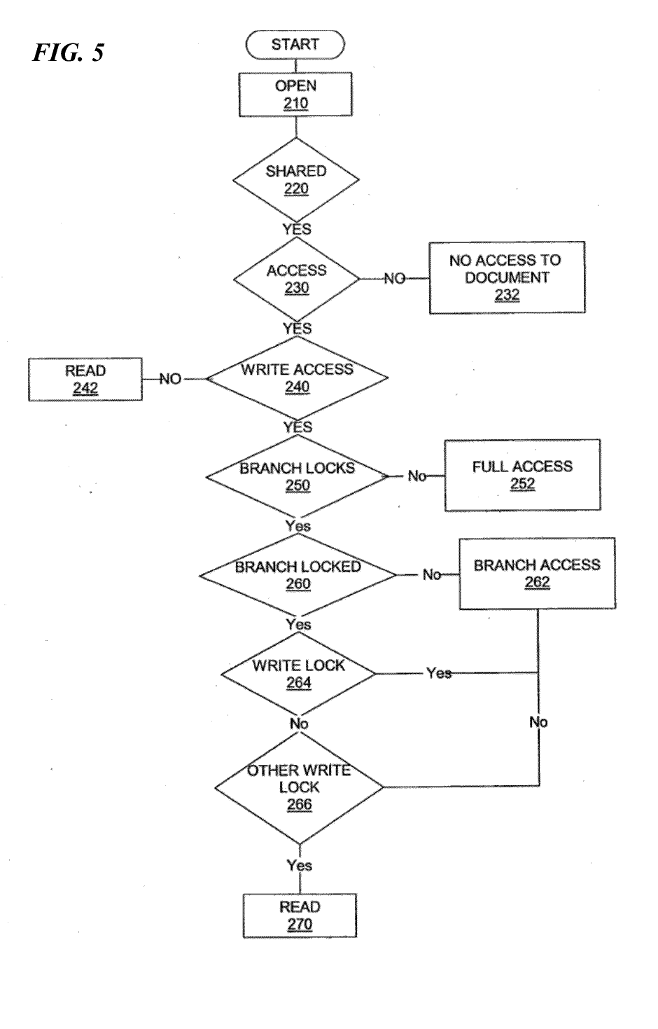

FIG. 3 illustrates an example of a document and interface for use by an organizer where branch locking is used. In this example, an agenda with branches is provided for a collaborative meeting in a shared mind map workspace. The opening remarks and the closing remarks are locked by the organizer, but access is permitted to one or more users to locked branches, such as Adam and Ulrik, in the example of FIG. 3. FIG. 4 illustrates an example of the interface as viewed by one user, Adam, which shows a lock on the closing remarks branch of the mind map document. In this example, the lock is a read-only lock that prevents Adam from editing anything in the closing remarks branch of the mind map. Alternatively, a write lock may be provided on a branch that permits only a designated user or users of the shared workspace the right to write and edit within a particular branch of a mind map within the mind mapping system. A flow chart is shown in FIG. 5. In this example, a shared mind map is opened 210 and the mind mapping system determines if the document is a shared document 220. If so, then the system determines if the user is permitted to share the document 230, and if so, then the system determines if the user has write permissions 240 in the document. Denial of access 232 or read-only access 242 may be granted by the system. If write permissions are granted, then the system continues to determine access to branches within the mind map document 250. If not branches are locked, then full read/write access is granted 252 to the user. Otherwise, access to certain branches is controlled 260 for each Branch ID, including child branches of a parent Branch ID. Unlocked branches may be fully accessed 262 by permitted users. Otherwise, the system checks to see if the particular user has a write lock 264, giving the user full access 262, or if another user does not have a write lock, then full access may be permitted 266. Otherwise, read only access is permitted 270 to the particular branch.

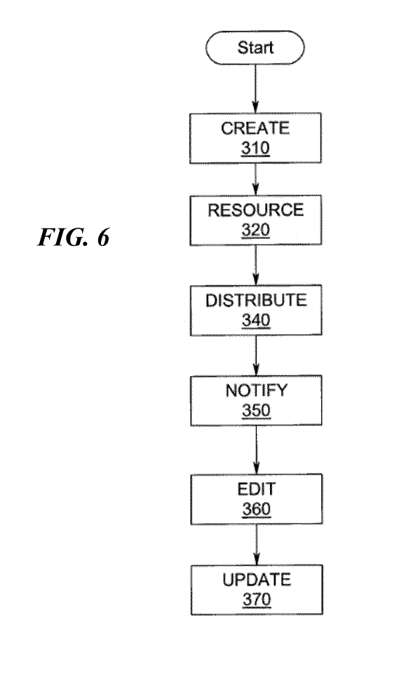

In another example, which may be combined with the previous examples, the system may provide access to distributed users at particular times or within particular time windows. For example, in FIG. 6, an organizer creates a mind map within the mind mapping system 310 and attaches information to one or more branches within the mind map 320. Resources may be added to one or more branches 330 by the organizer by entering the name and/or email addresses of the particular resources, granting access to the branch by the resources, with or without branch locking. The information may include a start time and an end time, and/or duration, which can automatically trigger an event, or the organizer may manually begin an event, which distributes 340 the task information in a branch to a shared workspace. For example, email notification 350 may be made to notify resources listed by the organizer in association with a Branch ID of the task. The task may be accessed in the shared workspace or information about the task may be exported to an external task scheduler or project management system, for example. In FIG. 6, the resource modifies the information in the branch directly in the shared workspace 360. The system can be updated automatically by a scheduled event or manually by the organizer, updating the organizer's mind map 370, based on input made by resources in the shared workspace, for example.

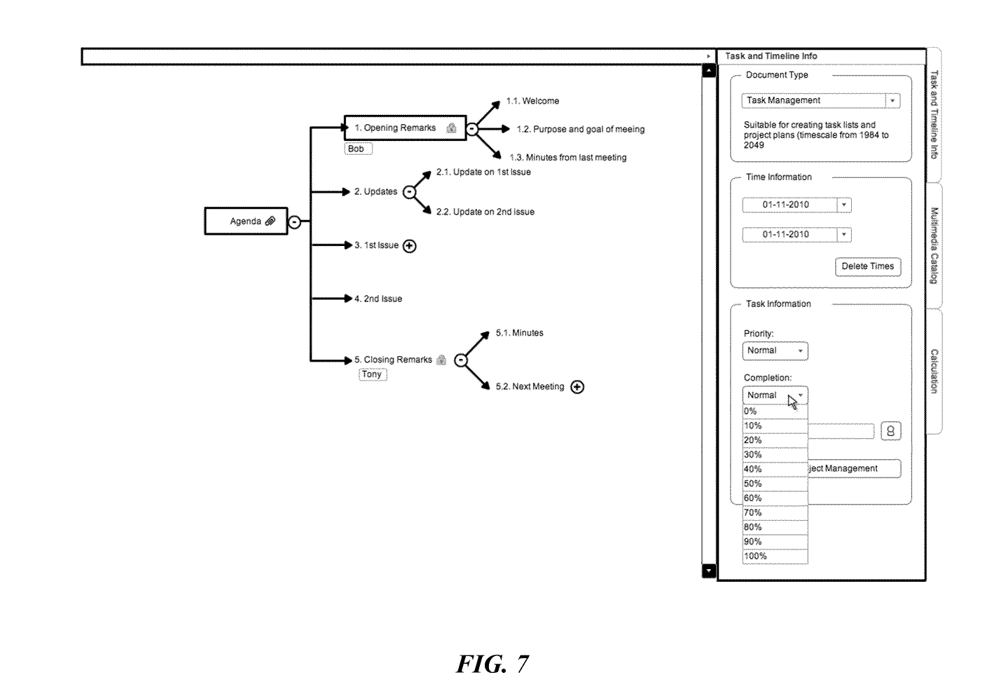

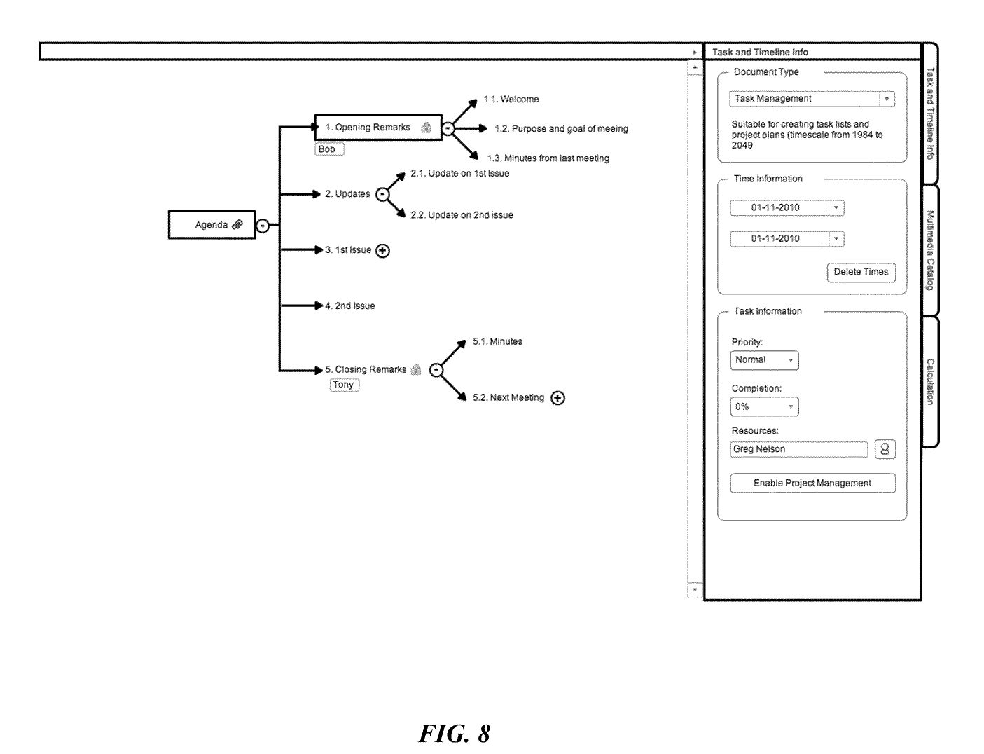

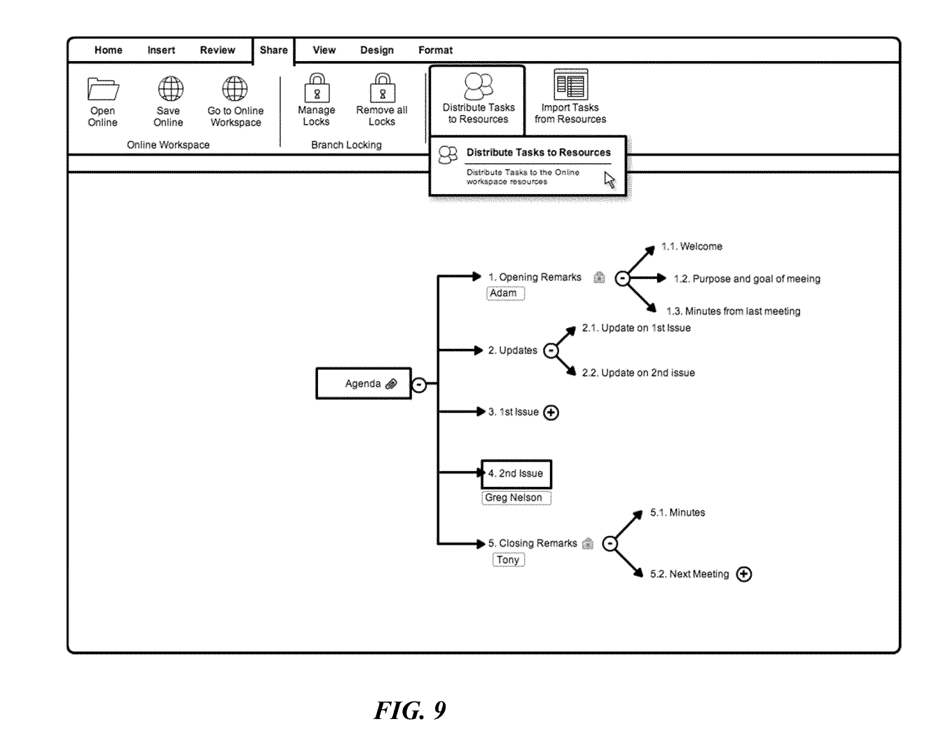

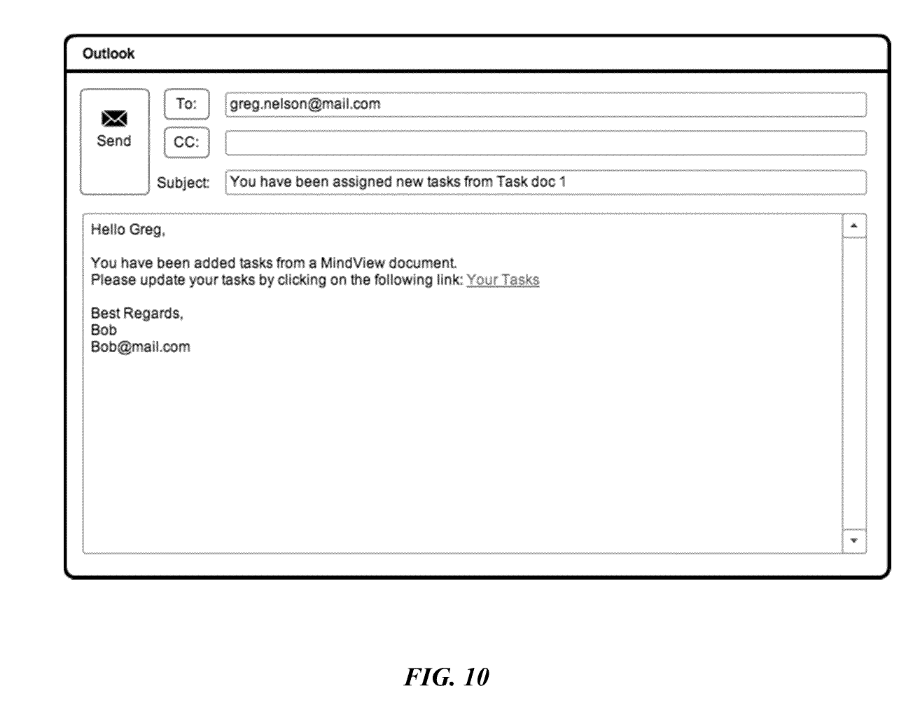

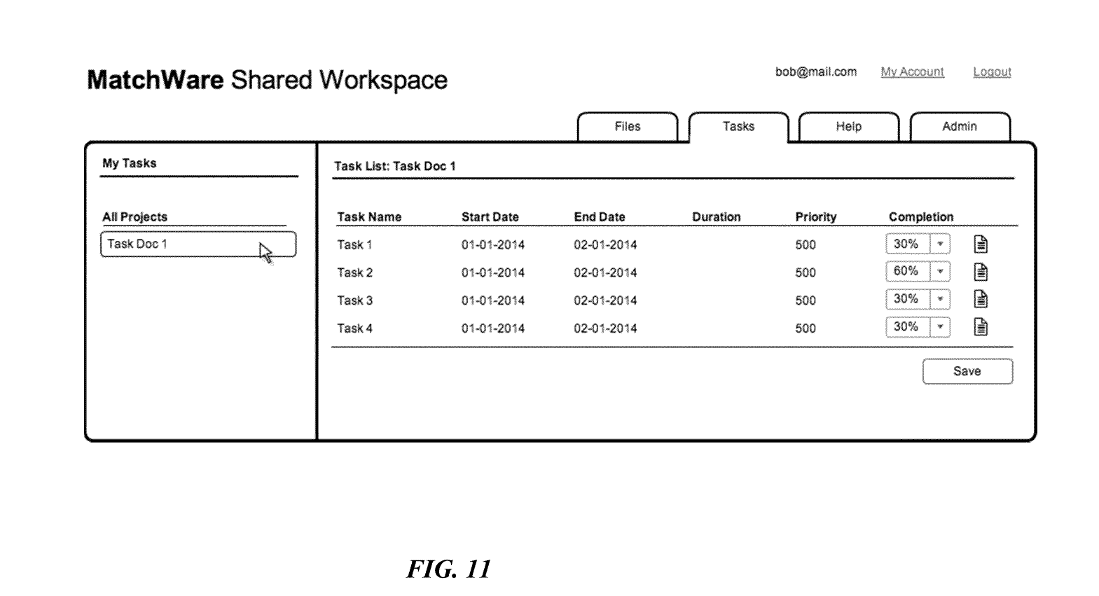

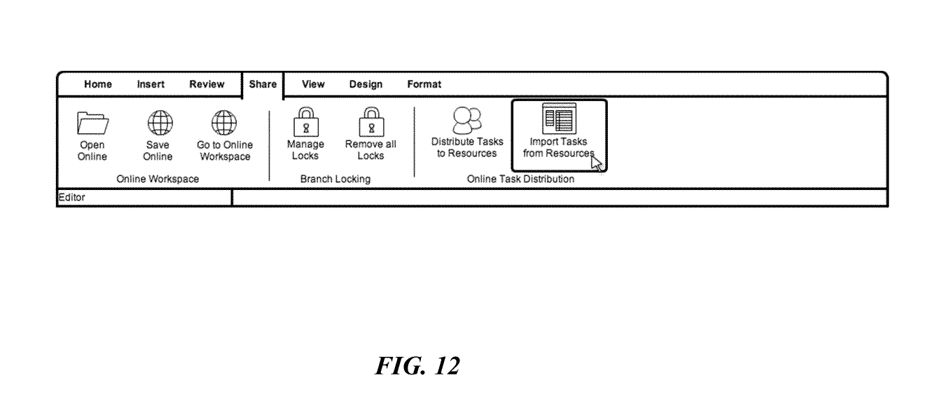

FIGS. 7 illustrates an example of an agenda mind map with a series of issues to be addressed in the mind map. An interface is provided for showing and editing information in each of the issues, with this example showing a 2nd issue, which is being modified to show that it is 40% complete. In the example of FIG. 8, the 2nd issue is shown as 0% complete, and the organizer is assigning Greg Nielsen as a resource, which is represented in FIG. 9 as a box associated with the branch designated as the 2nd issue in the agenda mind map. In FIG. 9, the organizer is manually triggering a distribution of the 2nd issue task to the resource, Greg Nielsen. FIG. 10 shows an email notification sent to Greg Nielsen, providing a hyperlink from the email to the agenda mind map in the shared workspace. FIG. 10 shows one example of a task list interface provided for tracking tasks for a plurality of projects within the shared workspace. In FIG. 11, the organizer is provided with an interface to import updated information from the shared workspace, which may be updated by resources, to the organizer's mind map document Task doc 1.

Topic Distribution and Scheduling

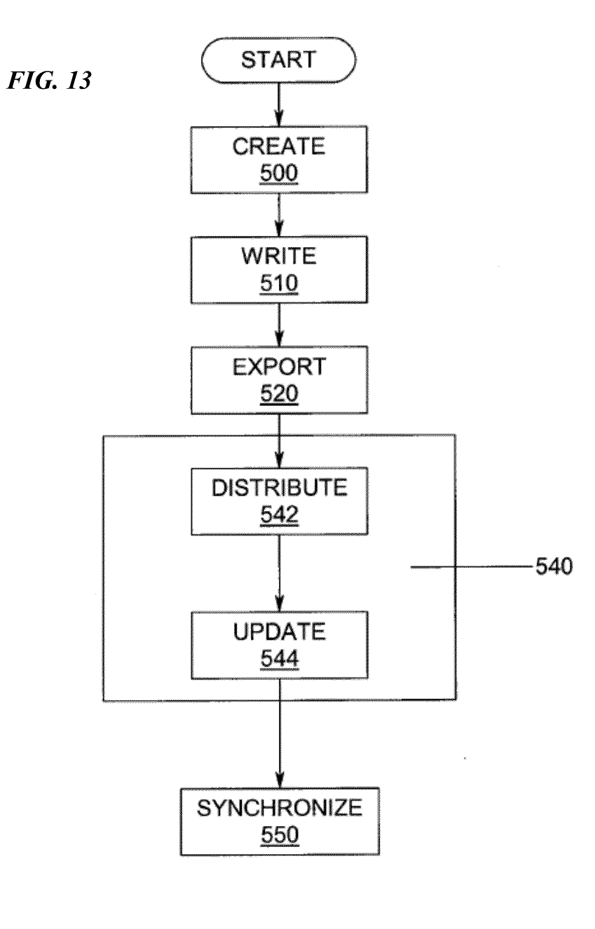

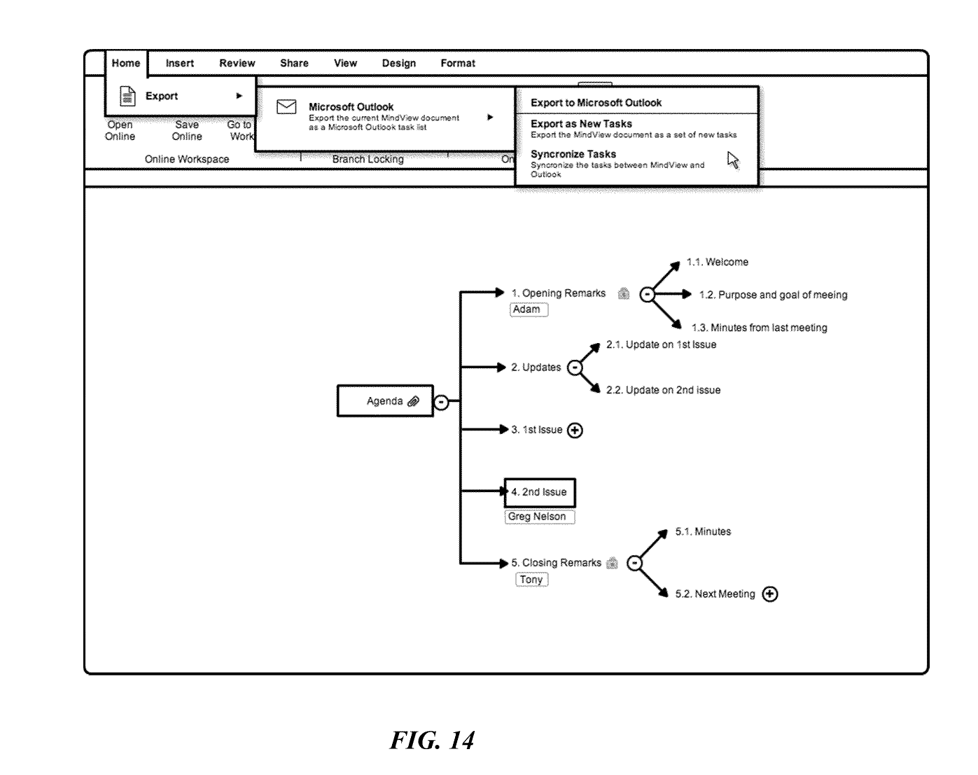

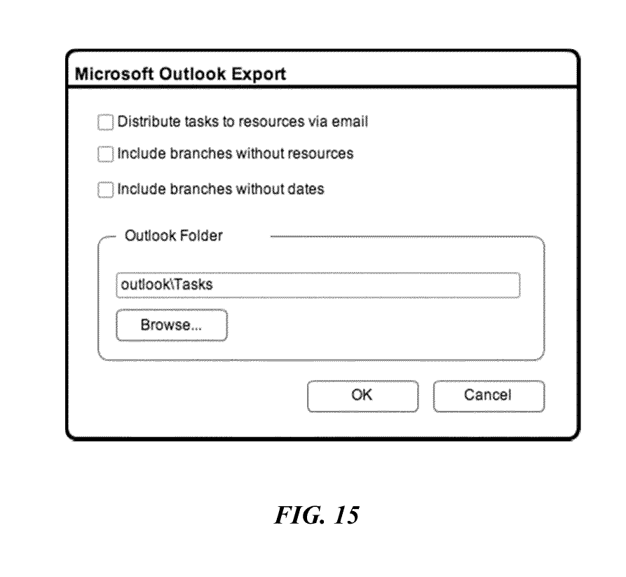

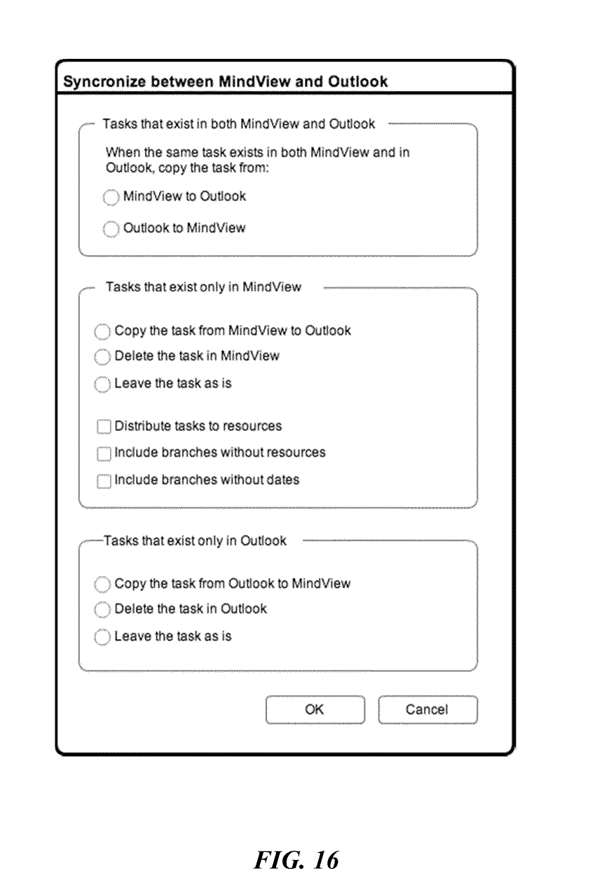

In FIGS. 13-16, an interface is provided for communicating with resources using an external task scheduling software, such as MICROSOFT OUTLOOK. In this example, a mind map is created 500 and information is associated with one or more branches 510 by the organizer of the mind map within the mind map system, which may include a plurality of resources associated with one or more branches, for example. The organizer exports 520 tasks to the resources using the export system to an external task tracking system 540, which is external to the mind mapping system. The organizer's external task tracking system 540 automatically distributes the tasks to one or more resources 542 listed in the mind map, which are associated with particular Branch ID's. Information in the tasks are updated by the resources and automatically update the organizer's and other resources external task tracking system 544. The organizer is capable of updated the mind map in a synchronization 550 process that updates the mind map of the organizer based on the updated information in the organizer's external task tracking system 540, such as OUTLOOK. For example, the task title, comments, start time, end time, priority, percentage complete and recipients may be input and/or updated by the organizer in the mind map, which may distribute, automatically, such information to resources listed by the organizer upon export of the mind map to the organizer's OUTLOOK task schedule. For example, FIG. 14 shows an interface for exporting and synchronizing information between the mind mapping system and an external task tracking system. The interface in FIG. 15 allows the organizer to specify whether to distribute tasks to resources via email, to include branches without resources and to include branches without dates in the exporting of a mind map to a shared workspace and/or to an external task tracking system. FIG. 16 illustrates a synchronization interface that allows the organizer to select certain parameters during synchronization, for example. The direction of the synchronization may be specified, and includes an interface for tasks that exist only in the mind mapping system. Such tasks may be copied from the mind mapping system to the external task tracking system, for example, or may be deleted from the mind mapping system. A plurality of options may be provided for distributing updated information to resources, for including branches without resources and for including branches without dates, for example. In addition, for tasks that exist only in OUTLOOK, the organizer may opt to copy the tasks from OUTLOOK to the mind mapping system, to delete the tasks from OUTLOOK or to leave the tasks unchanged. Thus, the interface may be highly configurable and flexible, providing a number of options for controlling the export and import of information between the organizer's mind map and an external task scheduling system, outside of the organizer's mind map, such as OUTLOOK or another popular project management or task scheduling solution.

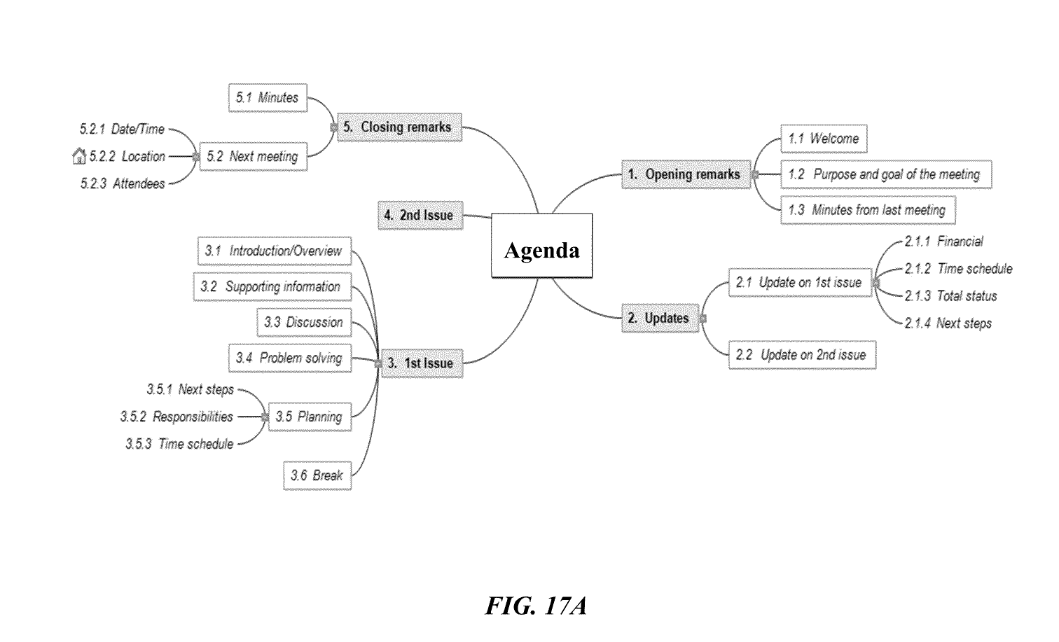

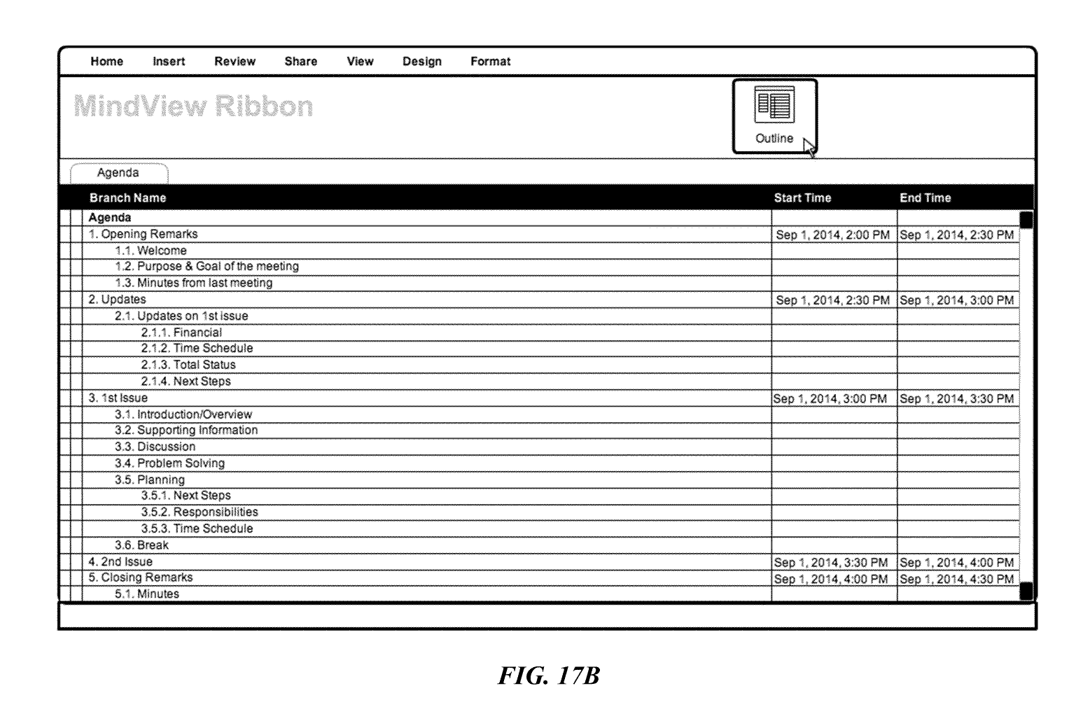

When creating an agenda electronically, whether online or offline, an agenda may be created as an outline as illustrated in FIG. 17B, for example, or a mind map as illustrated in FIG. 17A, for example. In an outline, each main topic will have its own line and sub topics may be illustrated by a simple indention or by a numbering schema. In a mind map the main topic may be a main branch extending from a root and the sup topic may be a sub branch, and so forth, for sub branches and the like. Whether the agenda is created as an outline or, a mind map, the system is capable of displaying one as the other and exporting either to an external report in any of the known document formats.

For example, a topic is defined as an agenda item where the meeting system will be able track information such as notes, comments, time spent, time remaining, duration assigned and the like. A topic can be classified as a break, which indicates that a break is planned in the meeting, for example, or a break may be input using a tool. Such a topic may be referred to as a topic-break. For example, if a topic contains a duration but no start and end time, it may be referred to as a non-fixed topic. A topic with a specific start and end time and/or duration may be referred to as a fixed topic. In the case when a topic does not contain either, it is referred to as a planned topic or a non-fixed topic without a specified duration. A valid agenda is defined as a list of topics, where the sum of the topics duration is less than or equal to the time span (i.e. duration between the start time and end time) of a meeting agenda. Each topic in a valid agenda starts when the previous topic in the list ends, for example. A first topic in the list may start at the; meeting start time, for example.

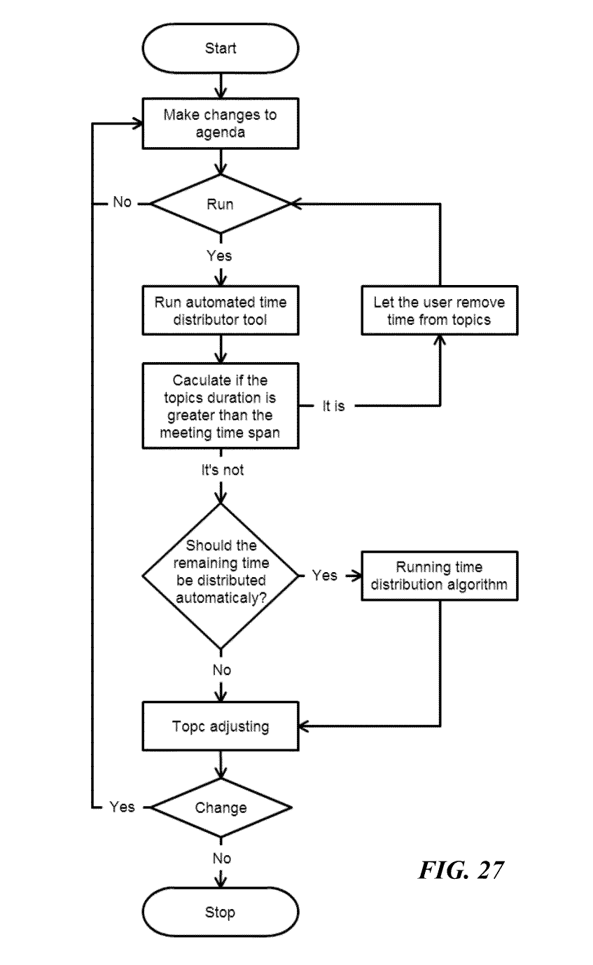

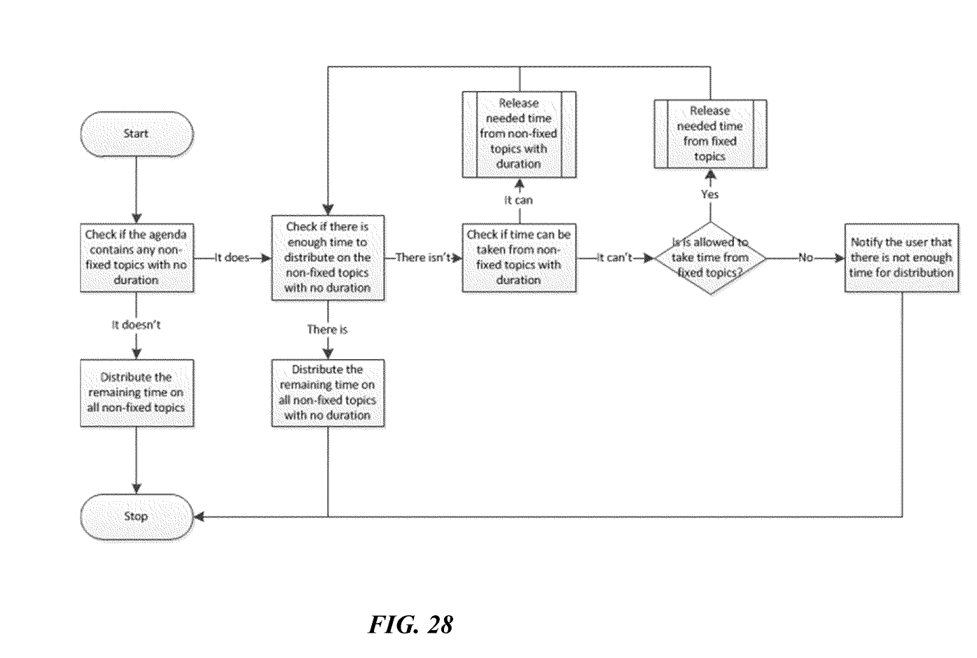

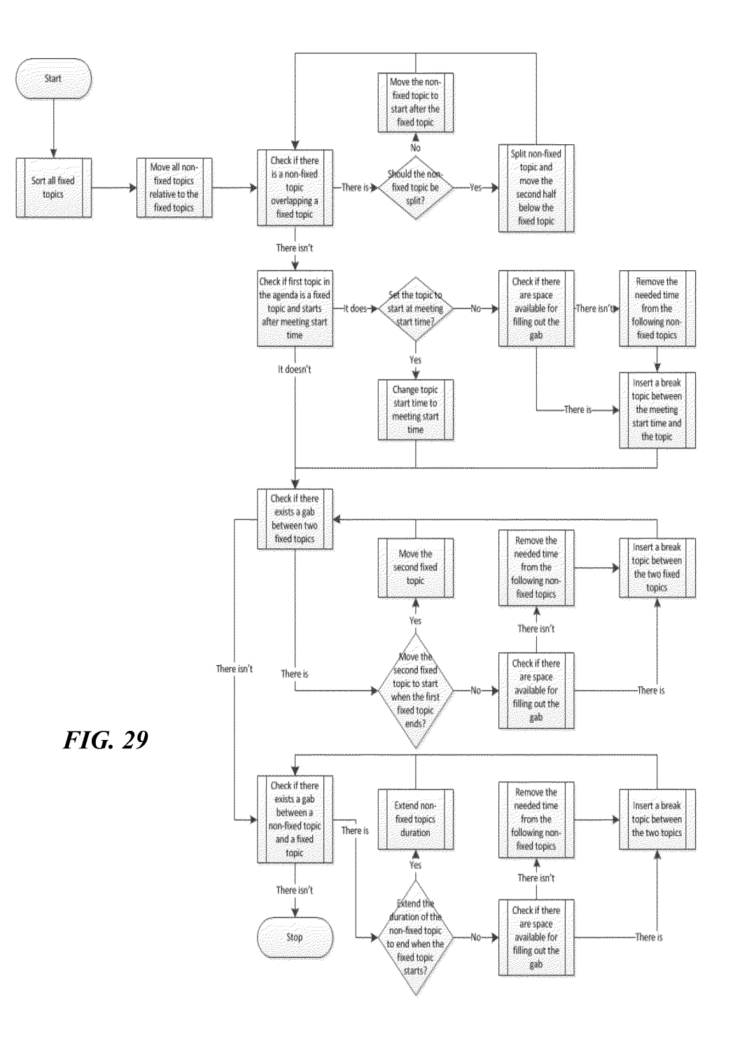

As shown in FIG. 27, for example, a tool may take a list of topics defined as above and may display run a time distributor tool and a topic adjusting tool, for example. The topic adjusting tool may be considered an agenda error correction tool, for example. If the sum of the topic durations exceeds the meeting time span, a user may be asked to remove time or topics from an agenda and the flow chart may terminate when all of the changes to the agenda are made. If the list contains any planned topics, the tool can automatically distribute remaining time on the planned topics so they become non-fixed topics with durations or it can ignore them and consider them as non-fixed topics with a duration of 0 (or no specified duration), for example. In the case where it distributes the remaining time on the planned topics, it may follow the flow chart of FIG. 28, for example. First, a check may be made to see if there is enough time remaining on the meeting to distribute to the planned topics. If not the system may take time from the non-fixed topics, and if that is not enough it may take time from fixed topics with the users permission or based on rules specified in the system. For example, where rules do not allow the tool to take time from fixed topics, it may notify the user that there is not enough available time and may terminate the system or return to a tool for the user to make changes to the agenda. A tool may be provided to prevent distributing only a brief duration, such as a minute or a few minutes on each planned topic. The system may have a setting for a rule to define a minimum duration for any topic. Once all topics have a duration, the topics may be rearranged and modified by the tool, as illustrated in FIG. 29, for example. The topic adjusting tool may locate each of the following errors in the agenda and fix the, for example

The first agenda topic is a non-fixed topic and starts after the meeting start time. The first agenda topic is a non-fixed topic and starts before the meeting start time. The first agenda topic is a fixed topic and start after the meeting start time. The first agenda topic is a fixed topic and start before the meeting start time. The agenda contains a gap between two fixed topics. The end time of a fixed topic overlaps the start time of a fixed topic. The agenda contains a gap between two non-fixed topics. The end time of a non-fixed topic overlaps the start time of a non-fixed topic. The agenda contains a gap between a non-fixed topic and a fixed topic. The end time of a non-fixed topic overlaps the start time of a fixed topic. The agenda contains a gap between a fixed topic and a non-fixed topic. The end time of a fixed topic overlaps the start time of a non-fixed topic. The start time of a non-fixed topic (A) begins after the start time of a non-fixed topic (B), and A is followed by B in the list. The topic before A in the list has an end time T, if there is no such topic then T is the start time of the meeting. The start time of a fixed topic (A) begins after the start time of a fixed topic (B), and A is followed by B in the list. The start time of a non-fixed topic (A) begins after the start time of a fixed topic (B), and A is followed by B in the list. The start time of a fixed topic (A) begins after the start time of a non-fixed topic (B), and A is followed by B in the list.

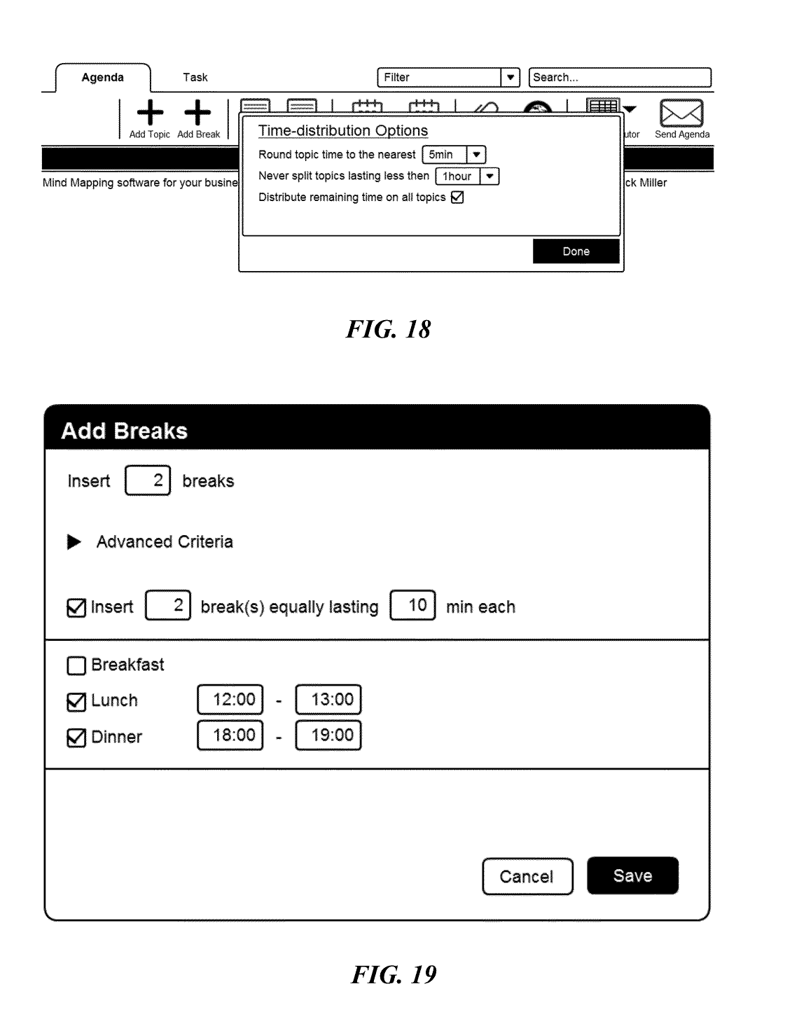

If the user prefers that all topics are not uneven or uncommon such as: from 2:31 to 2:49 pm etc., it is possible for the user to set a rounding tool as shown in FIG. 18, for example, to round all topics start and end time to the nearest specified number of minutes. The tool then does the rounding for all the start and end times before the system starts to fix the topic adjusting in the agenda, as illustrated in FIG. 29, for example.

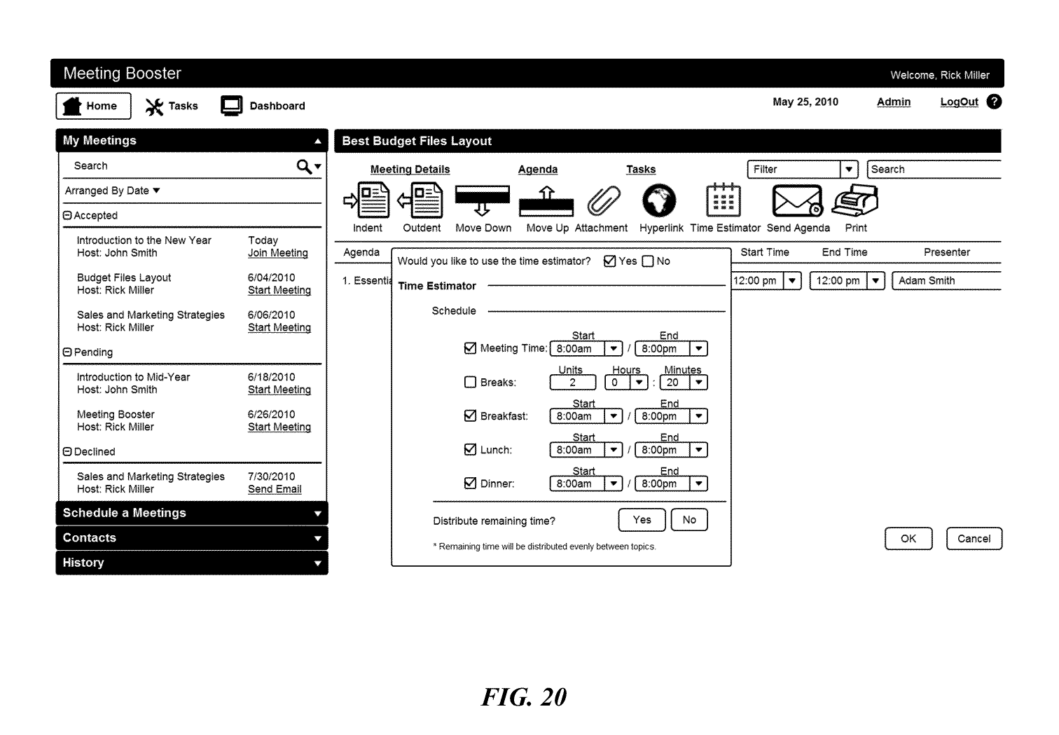

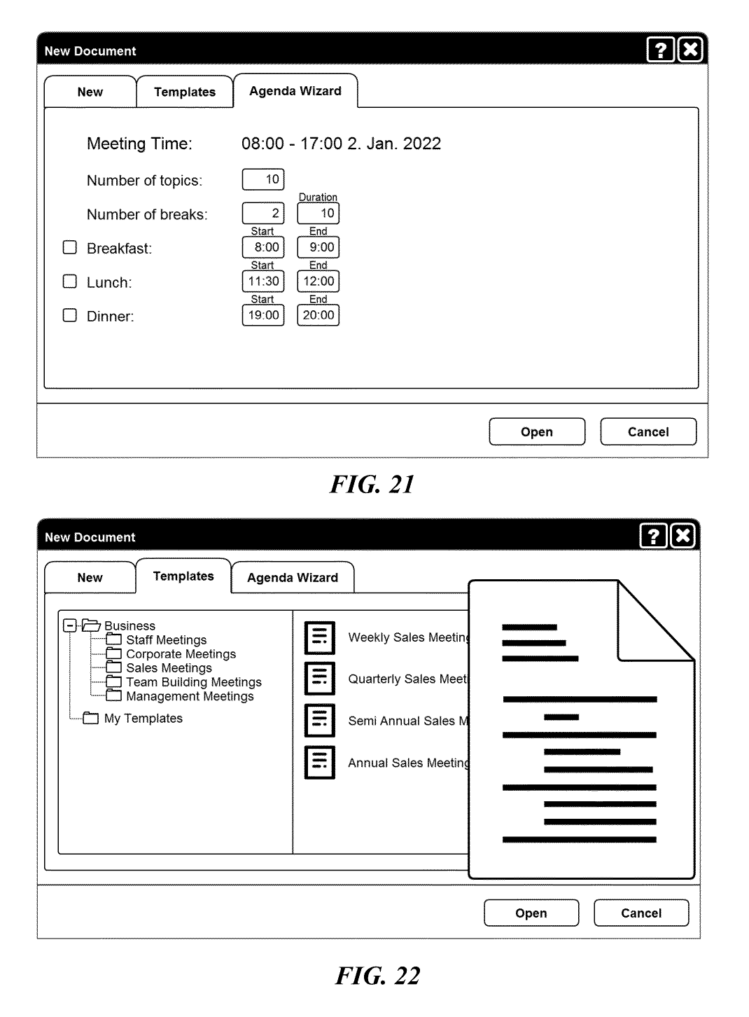

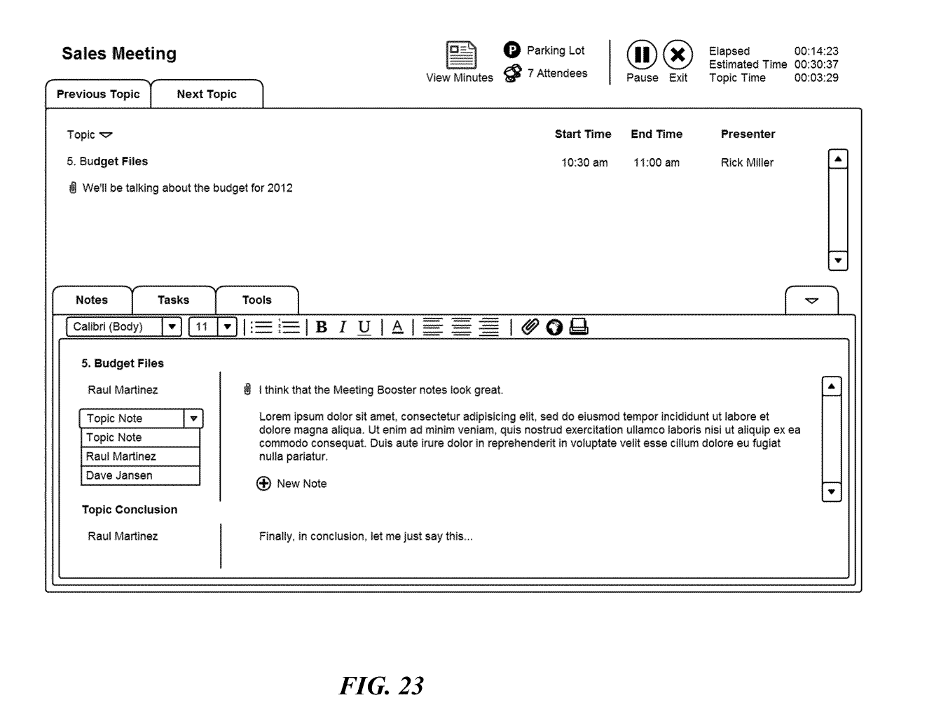

Breaks may either be inserted in the agenda before activating the time distribution feature as illustrated in FIG. 19 or may be included in the dialog for the time distribution feature illustrated in the example of FIG. 20, for example. Further, breaks can be inserted during the use of the agenda wizard, as illustrated in the example of FIG. 22, where a template is selected with pre-made topics first and then breaks are added as the second step.

Meeting Performance Reports and Analysis

Users may have the ability to collect meeting specific data from any number of meetings to be used in Dashboard style reports covering things like detailed meeting costs, high and low performing hosts or attendees, accountability relating to task completion, meeting performance based on if meetings are kept according to schedule relating to start and end times as well as the scheduled date of the meeting, for example.

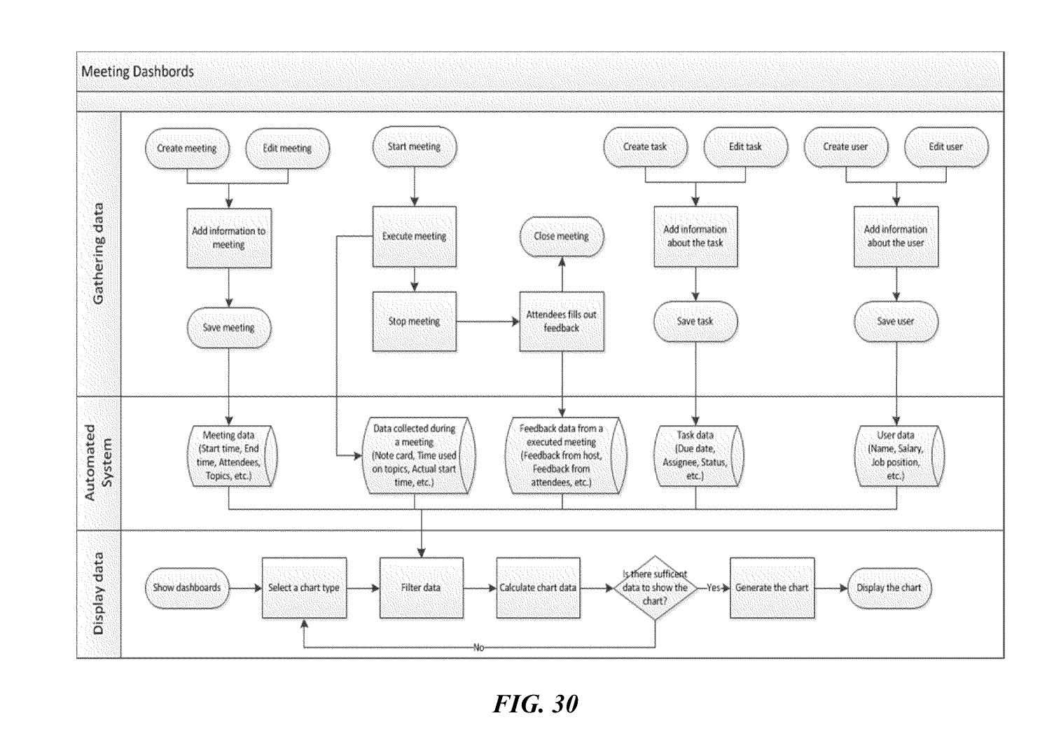

Via wizards, filters and custom settings, users can access meeting specific data from any number of meetings and can run Dashboard style reporting on such data to provide statistical information to be used for optimizing and streamline the meeting process, as illustrated in the flow chart example of FIG. 30, for example. Before the meeting starts, organizers can check mark which participants are present so the meeting management system can compare this to who accepted the meeting invitation. When executing a meeting an electronic note card can be used to take notes for each topic, including but not limited to; text notes, voting notes, ink drawing notes, pros and cons graphs, and so forth. The notes are later converted by the meeting management system into a meeting minutes report.

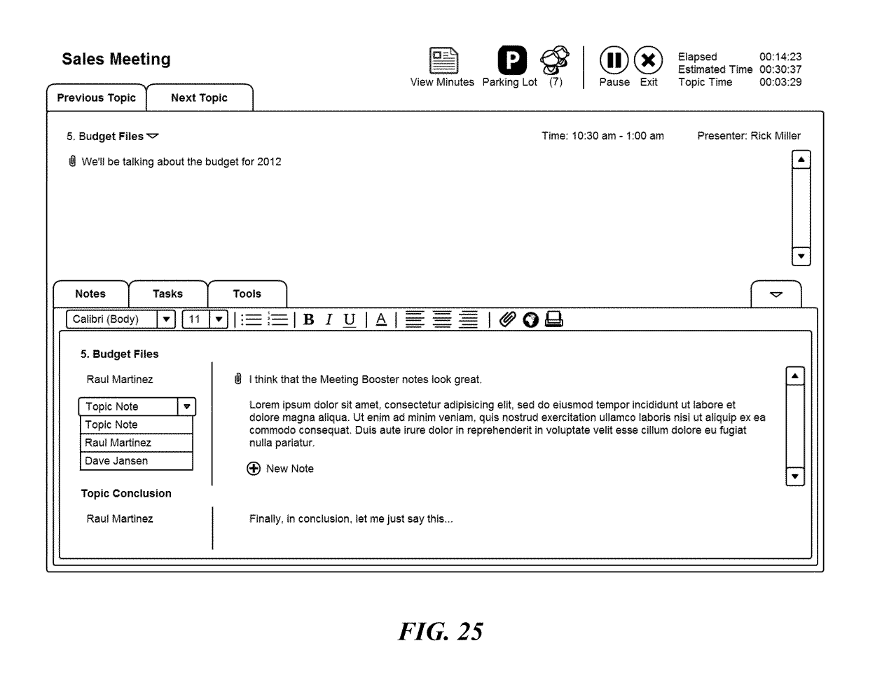

The invention also extends the note card so it captures notes made by individuals or as a group, per topic or for the meeting in general. The invention will further document what time such notes were made and who made them, the total time spend on topics, will allow for task allocation for each topic or for the meeting in general, voting results, mind maps, ink drawings, and so forth, as illustrated in the screen shot example of FIG. 25. The meeting management system will track if a topic is discussed within the time allocated, if the meeting is running late, starts late and so forth. The meeting management system also tracks if tasks are done on time and will be able to send reminders to users pertaining to such tasks. Users can have their individual “V-Card” where their location and status within the organization are listed as well as their salary. The system will be able to send out meeting feedback surveys, and such surveys could range from very basic to customizable 360 multi rating reports. This feedback can be anonymous or stated as a defined user. The invention is to create meeting performance data based on the combination of the captured notes from the note card, the tracking system and other information captured by the meeting management system. Key Performance Indicators such as Meeting Costs, Meeting Activity, Contribution, Absence, Best Host, Best Attendee, Best Meeting, Gap Analysis, Opportunities Report, Meeting evaluation reports and more will be created by the meeting management system. User will be able to run correlations on key parameters to explain differences for KPIs (Key performance Indicators).

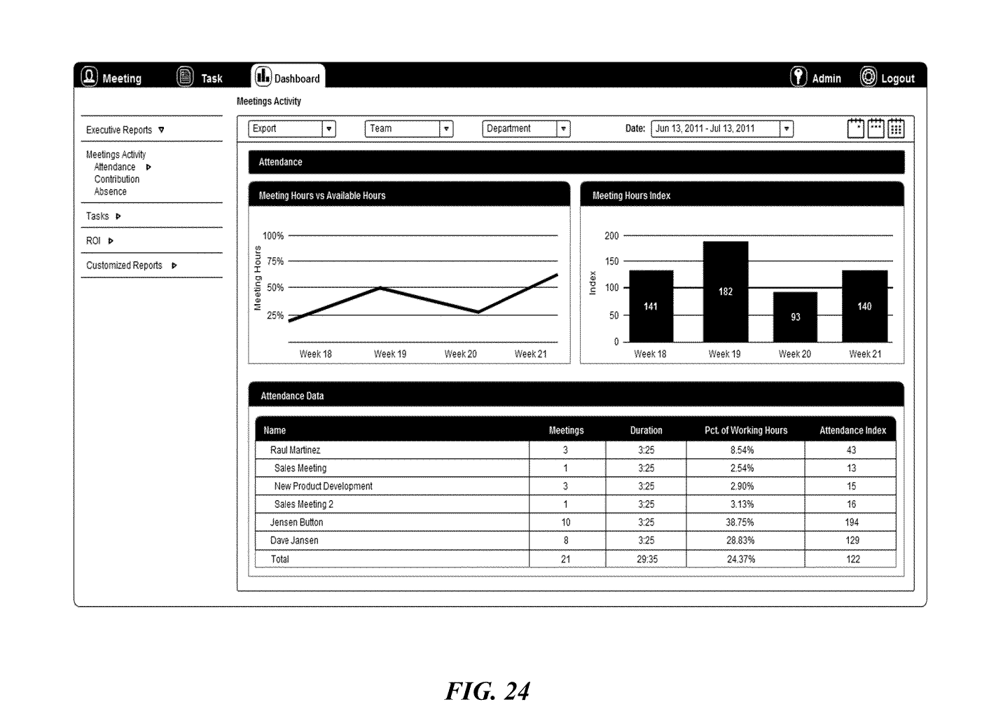

The computerized meeting management system may be integrated with other systems and could for instance export Meeting Appraisal information to Human Resources Management Systems, as illustrated in the example of a Meeting Performance Dashboard in FIG. 24.

Unaddressed Topics

The meeting management system according to the present invention may further include a method of automatically detecting unaddressed topics. Quite often, topics scheduled for a particular meeting are not addressed during that meeting. This may happen for a variety of reasons: discussion of some topics overflowing the allotted time resulting in other topics going unaddressed, a presenter for a topic being absent or unprepared, a topic being simply overlooked or purposely postponed (parked), etc.

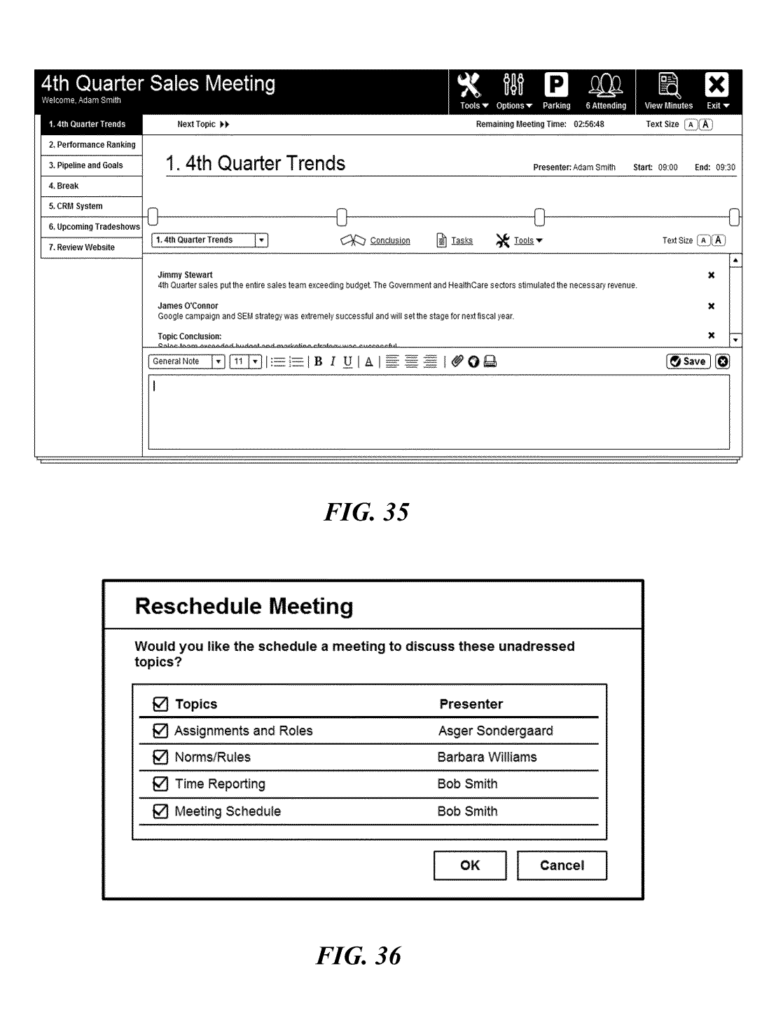

The meeting agenda includes an electronic list of tentative topics. As the meeting progresses, the meeting administrator, the topic presenter, or another authorized attendee activates a topic that is being discussed as illustrated in FIG. 35. The topics have not been activated during a meeting are automatically classified as unaddressed. While a topic is active, notes may be entered for that topic to document the discussion. The meeting management system tracks the amount of time during which the topic is active, the amount of notes entered for the topic, and whether the topic has a conclusion. The system then analyzes this information to detect unaddressed topics.

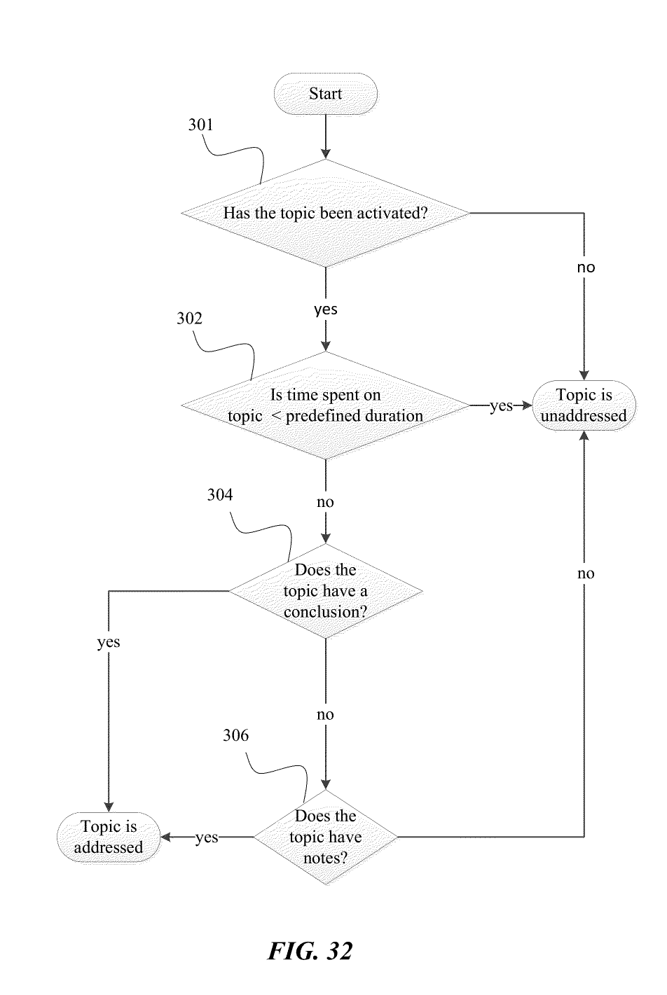

The method of detecting unaddressed topics according to the present invention is depicted in the flowchart of FIG. 32. The method involves a three-tier analysis. A topic may be classified as unaddressed if it fails to meet the following three conditions: (1) the topic was activated during the meeting; (12) the amount of time spent on the topic is equal to or greater than a predefined minimum duration, (3) the topic has a conclusion, and (4) the topic notes satisfy predetermined conditions (i.e. number of pages, number of characters, word count, headings, etc.).

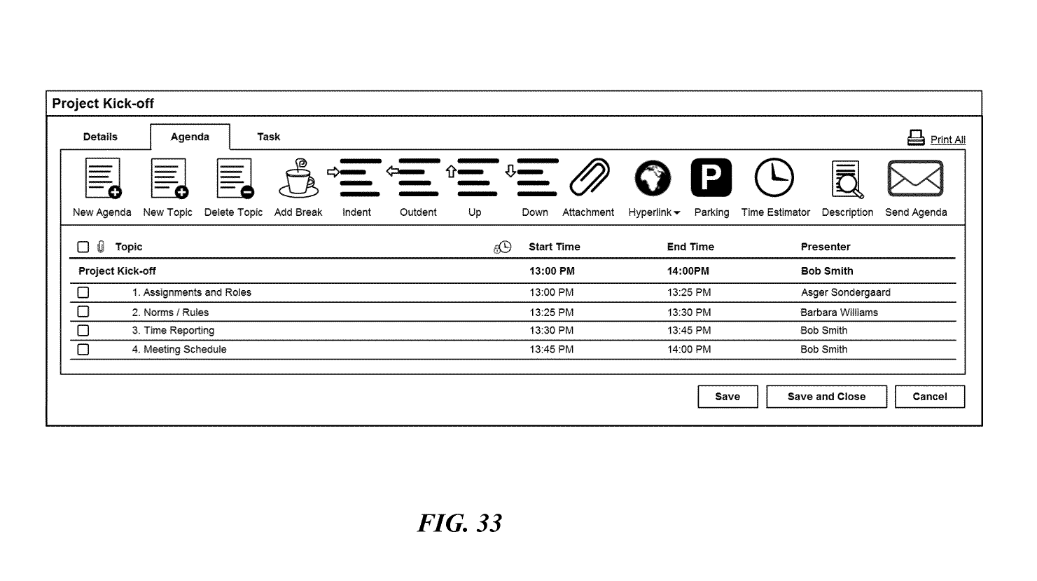

Referring to FIG. 32, in step 301, the system detects topics that were not activated during the meeting. All non-activated topics are automatically classified as unaddressed. In step 302, the system evaluates whether adequate amount of time has been dedicated to the topic during the meeting. This can be determined based on several predefined criteria. For example, in some embodiments, the administrator, the presenter, or another authorized user may specify the minimum acceptable duration of the discussion for a topic—if the topic was active for less than this predefined duration, then the topic will be classified as unaddressed. The minimum duration may be predefined for each individual topic. For example, in FIG. 33, the discussion of the Norms/Rules topic is scheduled to last for 35 minutes. The presenter for the topic or the meeting administrator may determine that this topic cannot be adequately address in less than 25 minutes. Accordingly, 25 minutes may be set as the minimum duration for the Norms/Rules topic—if during the meeting, this topic is active for a period of time exceeding the minimum 25-minute duration, the topic will be classified as addressed. Otherwise, the system will proceed to step 304.

For some meetings, it may be cumbersome to manually estimate and predefine the minimum adequate duration for each topic. To ameliorate this task, the minimum adequate duration may be defined as a percentage of the scheduled duration. For example, a minimum adequate duration for every topic may be predefined as 80% of the topic's scheduled duration. This will reduce the burden on presenters and meeting administrator to determine the minimum adequate duration for each individual topic. In FIG. 33, the Time Reporting topic is scheduled to last 15 minutes, if the rule that the topic discussion must last for at least 80% of the scheduled time applies, the system will automatically calculate and set the minimum adequate duration at 12 minutes. Accordingly, if the Time Reporting topic is active for longer than 12 minutes, the topic will be classified as addressed. It is also possible, that for some topics the minimum duration is defined individually, while for the remaining topics, automated rules based on percentage of the scheduled duration are applied.

If the topic was active for less than a predefined minimum duration, it is nevertheless possible that the topic was adequately addressed. To make this determination, the system proceeds to step 304, in which the system analyzes the notes for the topic to determine whether a Conclusion has been entered. The meeting administrator, note taker, presenter, or another authorized user with note entering capability may designate a note entry as a conclusion of the active topic as illustrated in FIG. 35. If the meeting management system determines in step 304 that the notes for a particular topic have a conclusion, then that topic will be classified as addressed regardless of whether its duration satisfied the predefined minimum duration condition. If the topic has no conclusion and the predefined minimum duration has not been met, the system proceeds to step 306.

In step 306, the system analyzes the notes for the topic to determine whether they comply with the predefined criteria—if they do not, the topic is classified as unaddressed. The predefined criteria may be based on the length of the notes (i.e. word count, number of sentences, number of characters, etc.). The predefined criteria may also be based on the attendees whose contributions were documented in the topic notes. For example, in FIG. 33, Barbara Williams is a designated presenter for Norms/Rules topic. A possible predefined condition may involve verifying that a note entry for Barbara Williams was made—absent such entry, the topic may be designated as unaddressed because the main presenter did not present the subject (or it was not properly documented). Some alternative possibilities for predefined rules based on topic note analysis of step 306 may involve verifying presence of specific keywords, headings, numbers, etc. If the meeting management system determines that the topic notes do not satisfy the predefined criteria, the topic will be classified as unaddressed.

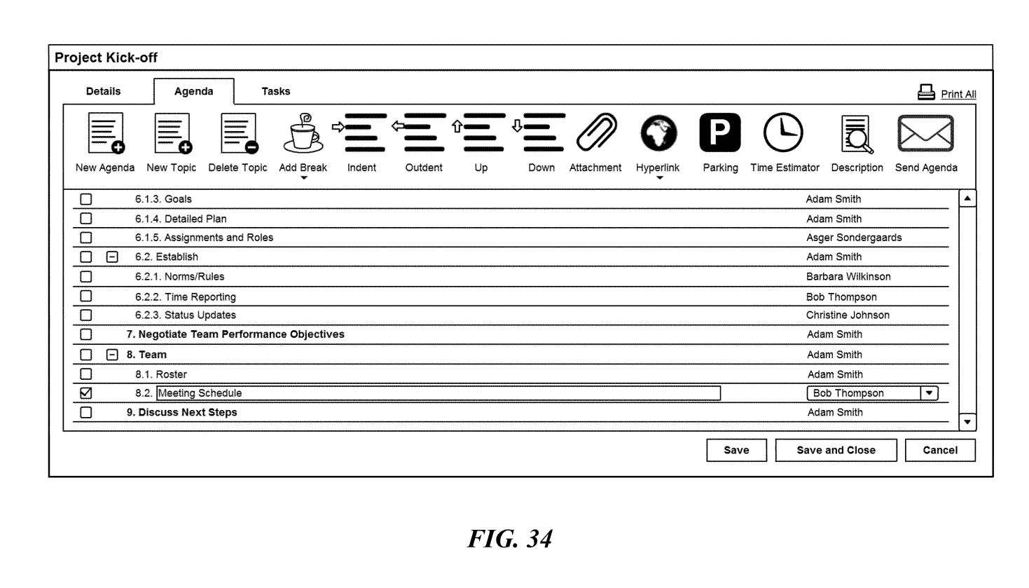

Some of the topics scheduled for a particular meeting may be skipped intentionally—this is referred to as “parking” a topic. Prior to or during a meeting, the meeting administrator or another authorized party may decide to forgo discussion of a certain topic. In such case, that topic may be parked by selecting the topic and clicking the Parking button in ribbon as depicted in FIG. 34. The meeting management system will skip over the parked topic and proceed to the next scheduled topic on the agenda. Once a topic has been parked, it is automatically classified as unaddressed.

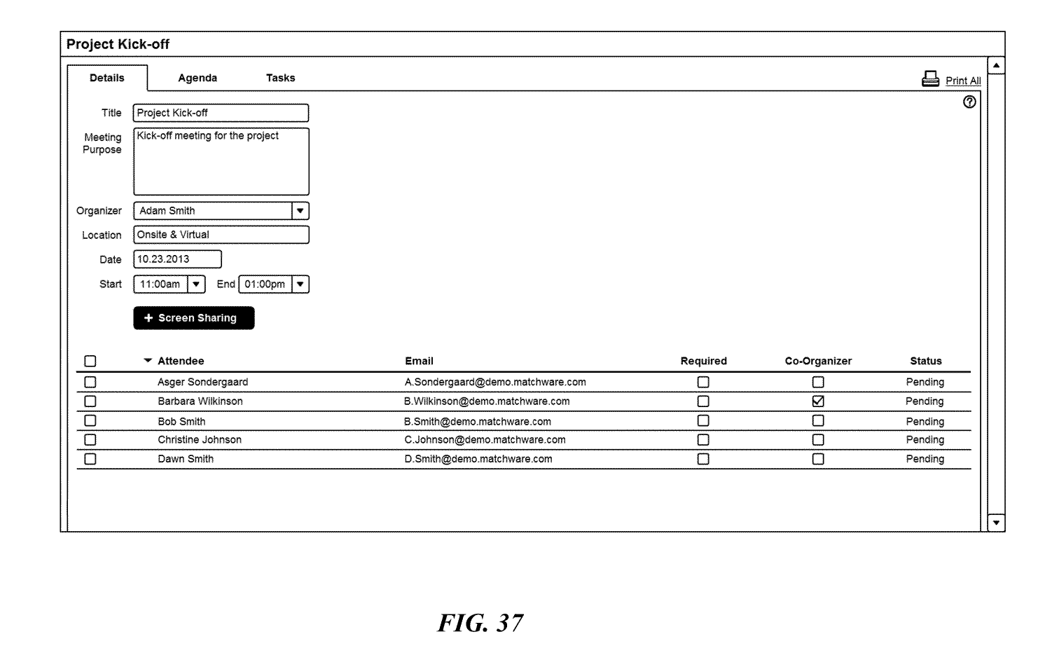

Upon completion of a meeting, the meeting management system evaluates the meeting topics according to the method disclosed above and automatically generates a list of all unaddressed topics for the meeting and presents the list to the meeting administrator as shown in FIG. 36. The administrator selects the unaddressed topics that he would like to reschedule for a subsequent meeting. The agenda for the follow-up meeting is filled in automatically—as shown in FIG. 37—based on the topic time distribution rules disclosed above, wherein the start time and the duration of each topic, the classification as fixed or non-fixed, and the designated presenter are carried over to the next meeting agenda. Other attributes of the unaddressed topic that may be automatically carried over for the follow-up meeting are tasks associated with the topic. For example, FIG. 33 illustrates a “Task” tab containing a list of the tasks associated with each topic and the name of the individual responsible for the task—the tasks for unaddressed topics are automatically transferred to the follow-up meeting.

The meeting management system makes the minutes and the task list from the original meeting readily accessible during the follow-up meeting to provide a quick reference point. This can be quite helpful because the topics that were not addressed during the original meeting are likely related to the other topics discussed at the original meeting. Accordingly, it is important that during the follow-up meeting the attendees may quickly reference the original meeting's minutes to facilitate a congruous and seamless discussion bridging the original and the follow-up meetings. In addition to the meetings minutes, various attachments associated with the original meeting may also be transferred to the follow-up meeting through linking, integration, or another method.

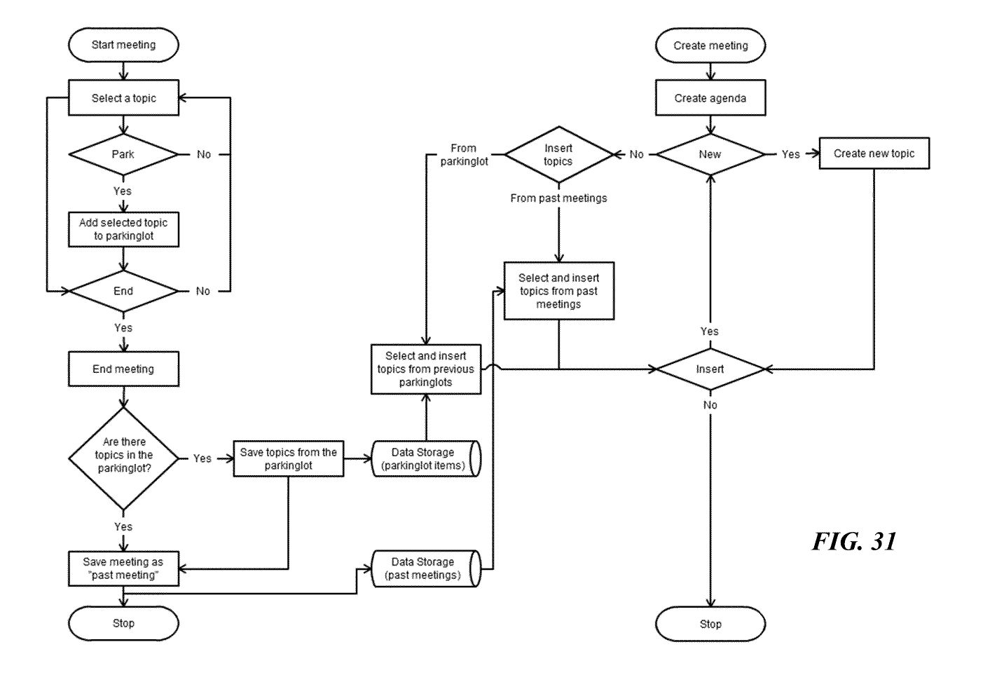

The meeting administrator may change any of the topic attributes and add additional topics when formulating agenda for the follow-up meeting. The step of including parked (unaddressed) topics in a new meeting is shown in the flowchart of FIG. 31.

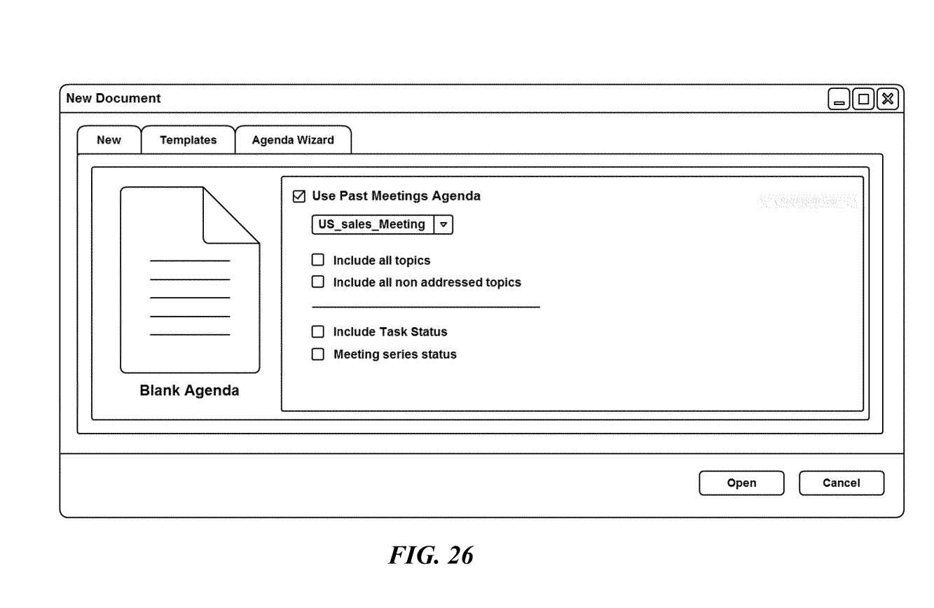

Unaddressed topics are accessible when making the new agenda. The user can read an overview of unaddressed topics, filter them by various options, and then drop selected topics directly into the new agenda outline. Previous agendas could be looked up as well when making a new agenda and the user can choose topics from previous agendas, and include them in the new agenda. Subject-based templates allow the user to select a template as a new agenda as illustrated in the example screen shot of FIG. 26.

After the agenda for the follow-up meeting is automatically filled in, the meeting administrator selects the date and time for the meeting. The meeting management system checks the personal schedules of all attendees to identify whether any scheduling conflicts arise. In some embodiments, the system may automatically schedule the meeting for the time that complies with all attendee's individual schedules.

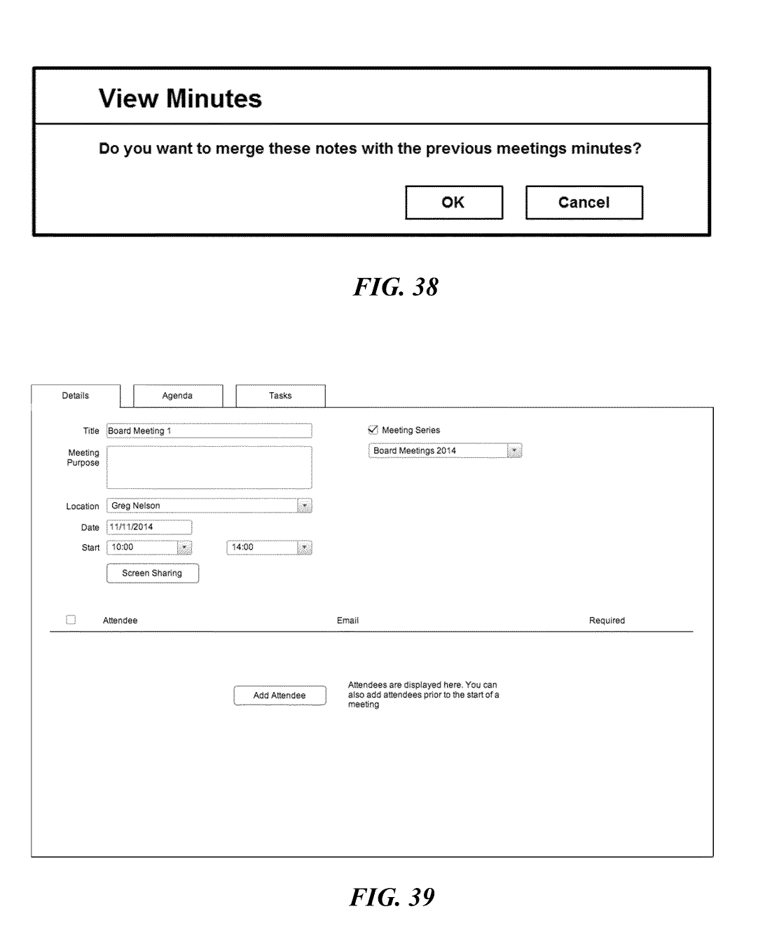

Referring to FIG. 38, upon completion of the follow-up meeting, there is an option to merge the notes for the follow-up meeting with the minutes from the original meeting. This may be accomplished by either combining the two sets of notes into a single document or linking the original minutes to the follow-up notes.

Meeting Series and Automated Task List Access Permissions and New Meeting Scheduling

Another aspect of the meeting management system according to the present invention relates to organization and management of a series of related meetings. The term Meeting Series as used herein refers to a plurality of related meetings that have one or more common characteristics, which may include topics, participant, and tasks.

The Meeting Series feature of the meeting management system provides unprecedented utility for administrators and participants of recurring meetings. This feature ameliorates the tedious task of scheduling meetings and inviting participants. The more significant benefit, however, is associated with task allocation, dynamic task lists, task-viewing permissions, automated modification of the meeting schedule based on task completion, and automatic scheduling of the meetings for the Meeting Series participants with outstanding uncompleted tasks.

When scheduling a new meeting, a user of the meeting management system is presented with a dialogue window, such as the one shown in FIG. 39. The user has an option to designate the new meeting as belonging to a Meeting Series by checking an appropriate box. The user then can either start a new Meeting Series or select an existing one from the list of available Meeting Series. The user only has access to the Meeting Series of which he is a member. This rule ensures that access to the Meeting Series and associated minutes, tasks, and attendee lists remain exclusive to the Meeting Series members.

A major advantage of the Meeting Series feature over the prior art is that it automatically pulls the tasks associated with the Series from each individual participant's docket and creates a separate task list dedicated to that Meeting Series. The dedicated Meeting Series task list may be viewed by the Series administrator and other Series members, while the members' individual tasks that are not associated with the Meeting Series remain inaccessible. This allows each member to maintain an individual docket, and only the tasks associated with the Meeting Series can be pulled from the individual dockets into the consolidated Meeting Series task list.

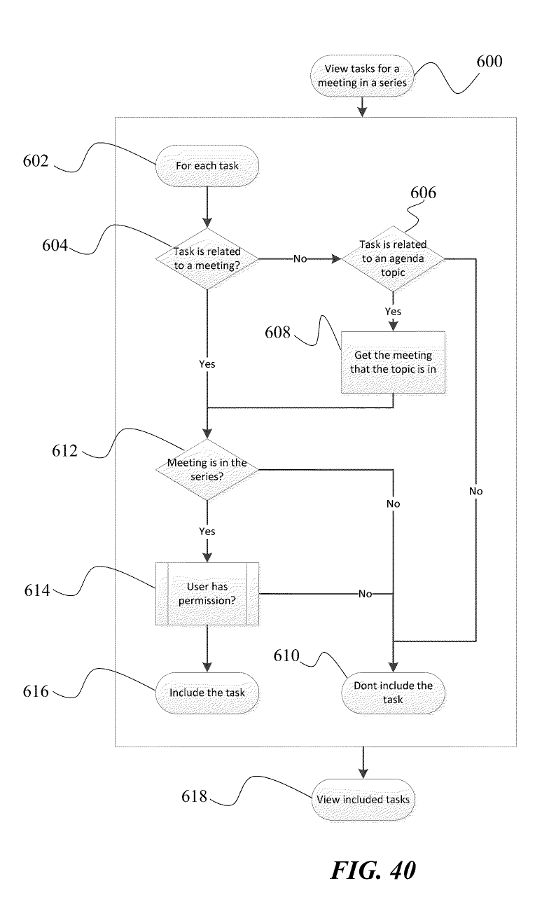

This feature is illustrated in the flowchart of FIG. 40. Responsive to a user's request to view tasks for a single meeting within a Meeting Series in step 600, the system proceeds to step 602, where for each task, the system determines whether the task is related to a meeting in step 604 or, alternatively, to an agenda topic within a meeting in step 606. The task that is not associated with a specific meeting, but is nevertheless is associated with an individual topic within the meeting, is classified as associated with that meeting in step 608. Tasks that are not related to either the meeting or an agenda topic within the meeting are classified as personal tasks and are not included on the Meeting Series task list in step 610. For those tasks that are associated with a meeting, the system determines whether the meeting is in the selected Meeting Series in step 612. Only those tasks that satisfy this criterion are added to the consolidated Meeting Series task list. Finally, the Meeting Series task list is filtered based on the access permission rules in step 614; the permission rules are discussed in more detail below. The tasks for which the user has adequate permission are included in the task list in step 616 and are outputted to the user in step 618.

The Meeting Series task list is dynamically updated based on the members' actions, such as rescheduling the deadlines, adding notes or subtasks, marking the tasks as completed, etc. The dynamic task list associated with the Meeting Series allows quick access to a comprehensive task list during an individual meeting within the Meeting Series. The task list may be filtered and sorted based on the specified criteria. For example, the task list may be adjusted to reflect all tasks belonging to the Meeting Series or only the tasks assigned during a particular meeting. When a new meeting is added to an existing Meeting Series, the tasks corresponding to the new meeting are automatically associated with the Meeting Series.

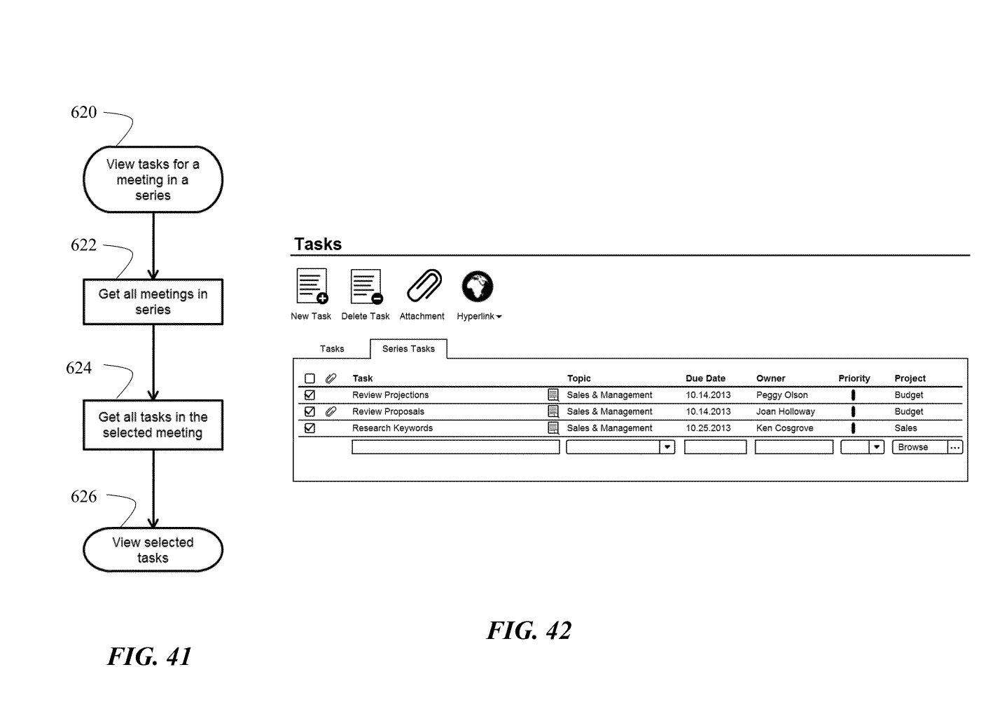

The Meeting Series task list is updated automatically allowing the Meeting Series members to access an up-to-date task listing. This allows for a global overview of all tasks belonging to all meetings within that Meeting Series as well as the tasks for the running meeting. Although the Meeting Series task list is comprehensive and contains all tasks associated with all meetings belonging to that Series, the system can filter the task list to reflect only the tasks for a particular meeting according to the logic illustrated in a flowchart of FIG. 41. Responsive to a user's request to view the task for a single meeting within the Meeting Series in step 620, the meeting management system retrieves all meetings within that Series in step 622. In step 624, the system identifies the user-specified meeting and retrieves the tasks associated with that single meeting. The final task list for the meeting is outputted to the user in step 626.

The task list may be provided to the user through a dialogue window depicted in FIG. 42. The window has two separate tabs: one containing all tasks associated with the running meeting, and another tab containing all open tasks associated with the entire Meeting Series. This aspect of the Meeting Series facilitates efficient meeting management and individual and collective performance evaluation.

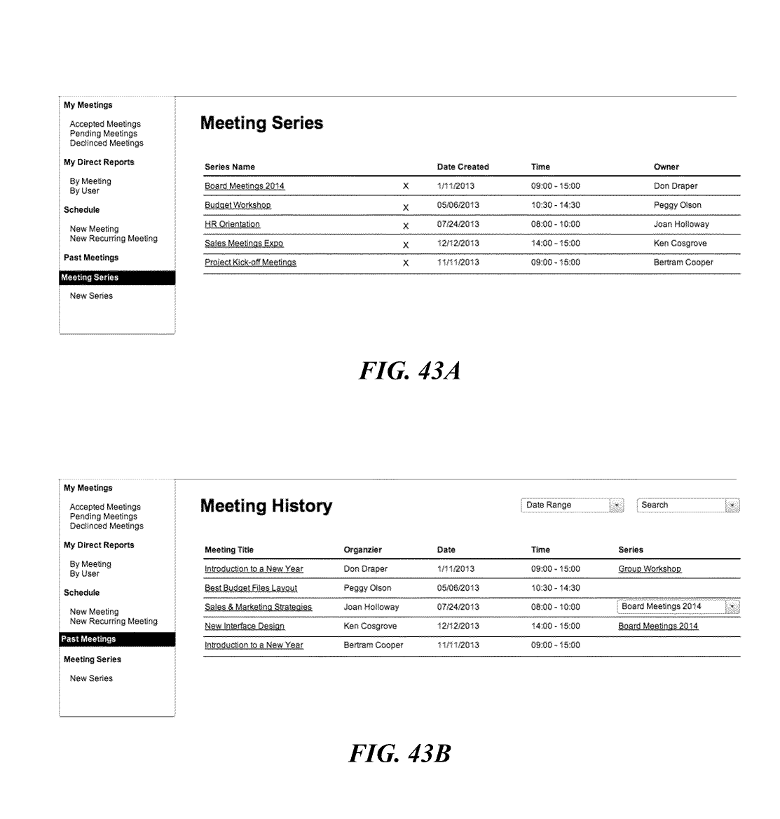

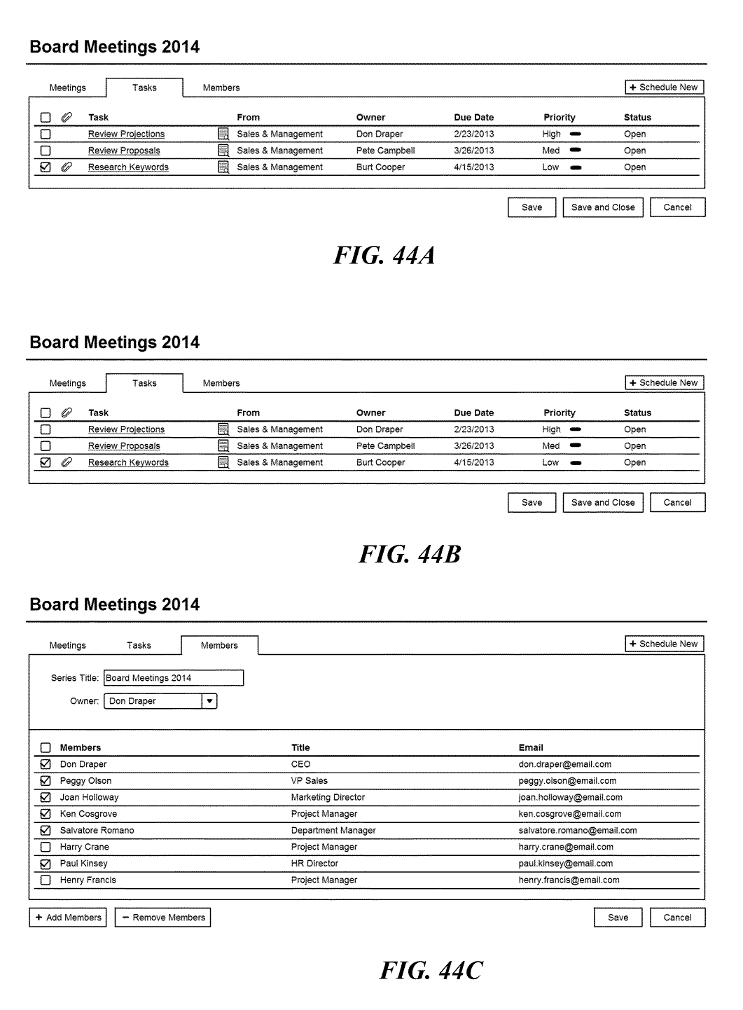

FIG. 43A shows a sample GUI window where the user can see a listing of all Meeting Series of which he is a member. In the same GUI window, the user may also view all individual meetings in which he has participated as shown in FIG. 43B. The user can select a particular Meeting Series by clicking its title. Responsive to the user input, a dialogue window, such as the one shown in FIG. 44A, will be presented to the user. The dialogue box shows a listing of all individual meetings included in that Meeting Series. Some basic key information about each meeting, such as date of the meeting and its organizer are provided under the Meetings tab. The outstanding tasks associated with the Meeting Series, are displayed under the Tasks tab as shown in FIG. 44B. Each task is assigned to at least one member of that Meeting Series. Each task may have a specific due date and a priority level ranging from low to medium to high. All members that belong to the selected Meeting Series are listed under the Members tab as shown in FIG. 44C.

The meeting administrator or another authorized user has an ability to schedule a new meeting from the Meeting Series dialogue window, shown in FIGS. 44A-C, by selecting the “Schedule New” button. The new meeting automatically becomes a part of the active Meeting Series. When the user elects to schedule a new meeting within the active Meeting Series, the system automatically generates a proposed attendee list based on the members belonging to that Meeting Series.

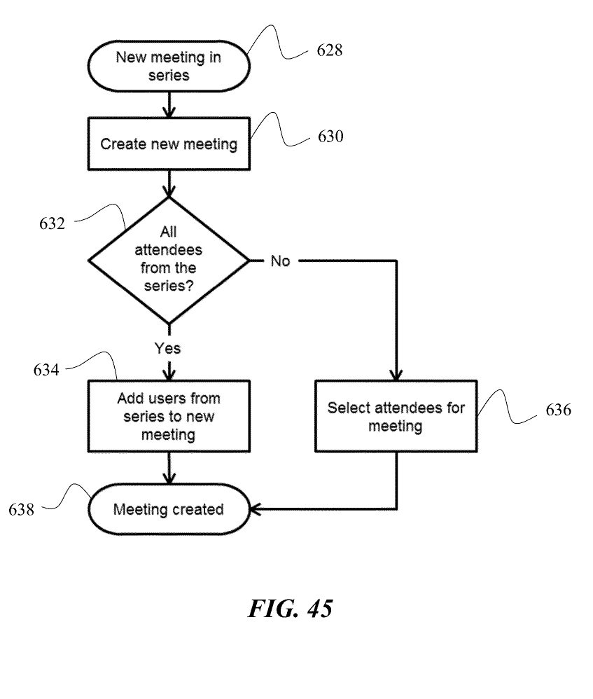

The user creating the meeting can modify the prepopulated attendee list by removing or adding members according to the logic schematically illustrated in FIG. 45. Responsive to a user's request to creating a new meeting within the Meeting Series in step 628, the meeting management system creates a new meeting in step 630. In step 632, the system inquires whether all attendees associated with the Meeting Series will be associated with the new meeting. If the user responds in affirmative, than the meeting management system will automatically add all members of the Meeting Series to the new meeting in step 634. Otherwise, the system will allow the user to select the members of the Meeting Series that the users wishes to associate with the new meeting in step 636. The system then finalizes creation of the new meeting in step 638.

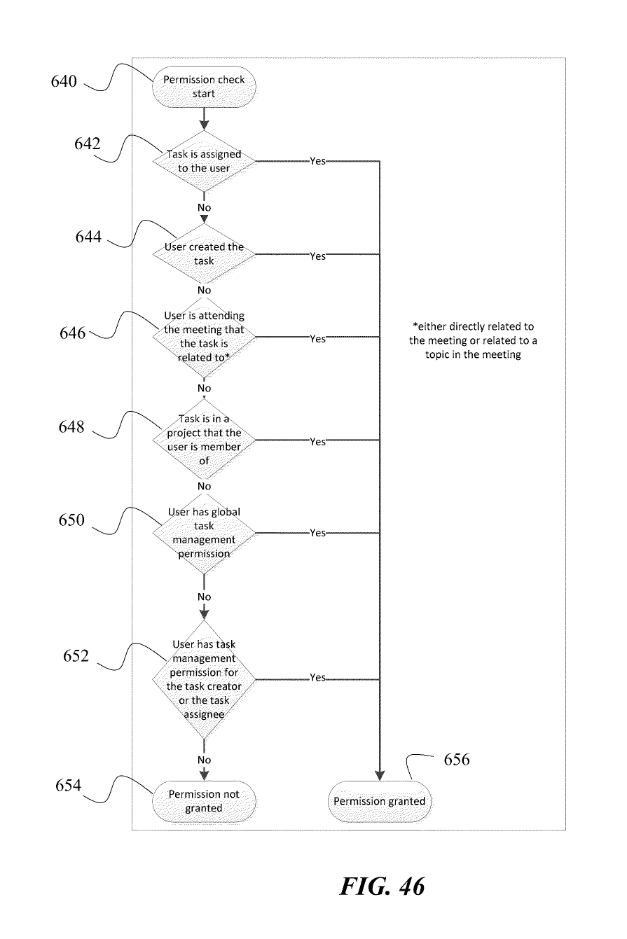

One of the key functionalities of the Meeting Series is illustrated in FIG. 46. This functionality is associated with the rules for establishing permissions to view various task lists. For each task on the task list, the meeting management system initiates a permission check in step 640 to determine whether the user has a permission to view the task. A permission to view the task is granted to the user in step 656 responsive to at least one of the following conditions being satisfied: the task is assigned to the user 642, the task was created by the user 644, the task is associated with a meeting the user is attending or has attended 646, the task is a part of a project of which the user is a member 648; users with a global task management permission 650 or those to whom the task creator or the task assignee has granted a permission 652 can also access the task. If none of the above conditions are satisfied, the system does not grant the user a permission to access the task in step 654. The task list that is ultimately provided to the user is filtered to include only the tasks for which the user has been granted a permission.

In addition, there are several special situations, each with its own set of rules. First, if an individual who is not a member of the Meeting Series is invited to attend a single meeting belonging to the Meeting Series, that attendee will not automatically become a member of the Meeting Series and, therefore, will not have permission to access the minutes or the task list for the Meeting Series. The Attendee will only have access to the tasks assigned specifically to him during the meeting he attended.

Second, if an individual is a member of the Meeting Series, but is not invited to a particular meeting within the Series, that individual will not have access to that meeting's minutes and task list. When that individual reviews the minutes and the task list for the entire Meeting Series, the minutes and the task list associated with the meeting to which he was not invited will be omitted.

The meeting management system may include additional features configured to automate the scheduling of the meetings. For example, the system may automatically schedule a meeting on a predefined date and time for those Meeting Series members with uncompleted tasks. This feature allows the Meeting Series members to monitor outstanding tasks to ensure that the project does not fall behind. This feature also creates an accountability mechanism where the Meeting Series members who do not complete the assigned tasks on time have to discuss their progress with other members of the Meeting Series. This may further create an environment conducive of cooperation and allow those who fall behind to seek timely assistance from their colleagues. The system may also create a ranking system based on the individual or group performance automatically measured by the ability to timely complete assigned tasks. The system may also automatically modify the scheduled meeting based on the task status: for example, if all tasks for a follow-up meeting are completed prior to the meeting, then the meeting may be cancelled as unnecessary. The status of a meeting be one of the following: completed, postponed, pending, uncompleted, overdue, rescheduled, or a combination thereof. The status may be changed by a user with a sufficient permission. The meeting administrator may override any action automatically taken by the meeting management system giving him full control over the meeting scheduling, tasks lists, and members.

### GLOSSARY OF CLAIM TERMS:

Completed: a task object has a completed status when the required action has been fully carried out.

Linking: associating, connecting, or assigning

Meeting: a session in which a group of users communicate via the Internet, telephone, or in person. A meeting may be synchronous or asynchronous.

Meeting series: a set of related meetings that have one or more common characteristics, which may include discussion topics, participants, and task objects.

Member: a user who is a participant of a meeting series.

Overdue: a task object has an overdue status when required action has not been fully carried out by the deadline associated with the task object.

Pending: a task object has a pending status when required action has not been fully carried out.

Permission: authorization to view and/or access a task list or a task object. Several level of permissions may exists: for example, some users may only have a permission to view a task object, while others may have a permission to change the status of the task object or its due date or the user with to whom the task object is assigned.

Postponed: a task object has a postponed status when required action has not been fully carried out and no specific deadline is assigned for the completion of the task object.

Reassigned: a task object has a reassigned status when the user/member who is required to carry out an action has been changed to a different user/member than the one originally assigned.

Rescheduled: a task object has a rescheduled status when the deadline for the required action has been set for a different date than the one originally assigned.

Status: indication of progress with respect to a task object. The status may be one of the following: completed, postponed, pending, uncompleted, overdue, rescheduled, or a combination thereof. The status may be changed by a user/member with a sufficient permission.

Task list: a list of task objects. The task list may include task objects associated with an individual user/member, a group of users/members, a single meeting, or a meeting series. Task list may be dynamic and may be filtered according to the permissions of the user viewing the task list.

Task object: is an assignment requiring an action from one or more users/members. A task objects is associating with a meeting and is delegated to an individual user or a group of users. A task object may have a specific deadline for completion and may involve several subtasks, follow-up tasks, or a combination thereof. The task object may have a status, which may be changed by a user/member with sufficient permission.

User: is a meeting administrator, a meeting attendee, or another party interacting with the computer software program. The user may or may not be a member of the Meeting Series.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A non-transitory tangible computer-readable media having computer-executable instructions for performing a method by running a software program on a computer, the computer operating under an operating system, the method including issuing instructions from the software program to perform a series of steps comprising:
establishing a meeting series having a plurality of meetings, each meeting having a plurality of task objects;
assigning a plurality of members to the meeting series;
linking the task objects to the members of the meeting series;
authenticating a user into the software program;
responsive to a first user input, generating a task list, wherein generation of the task list comprises the steps of:
retrieving all task objects associated with the plurality of meetings within the meeting series;
filtering the retrieved task objects based on a predefined set of user access permissions to identify a first plurality of task objects linked to the user and a second plurality of task objects the user is permitted to access;
populating the task list with the first and the second pluralities of task objects;
outputting the task list to the user; and
responsive to a second user input, filtering the task list to contain only the task objects associated with an individual meeting from the plurality of meetings within the meeting series.

2. The media of claim 1, wherein the predefined set of user access permissions is configured to grant the user access to task objects created by the user, task objects associated with a meeting attended by the user, task objects in a project the user is a member of, task objects for which the user has a global task management permission, and task objects assigned to the meeting series members over whom the user has management authority.

3. The media of claim 1, further comprising the steps of:
creating a new meeting within the meeting series;
automatically prepopulating a member list for the new meeting with names of the members of the meeting series; and
electronically sending a meeting invitation to each confirmed member.

4. The media of claim 1, further comprising the steps of:
detecting a status of a first of the plurality of task objects; and
responsive to detection of a change in the status, automatically updating the task list to show a new status of the first task object.

5. The media of claim 4, wherein the status is selected from the group consisting of completed, pending, overdue, postponed, rescheduled, reassigned, and a combination thereof.

6. The media of claim 1, further comprising the steps of:
detecting a first plurality of task objects with a predetermined status within the plurality of task objects;
responsive to detecting the first plurality of task objects, automatically creating a new meeting within the meeting series;
associating the first plurality of task objects with the new meeting; and electronically sending a meeting invitation to each member linked to at least one of the first plurality of task objects.

7. The media of claim 1, further comprising the steps of:
determining a status of each of the plurality of task objects associated with a first meeting within the meeting series, and
responsive to determining that all task objects have been completed, cancelling the first meeting.

8. The media of claim 1, wherein a non-member attendee of a first meeting within the meeting series is only granted a permission to access the task objects associated with the first meeting.

9. The media of claim 1, wherein a system administrator has a permission to add or remove members of the meeting series.

10. A non-transitory tangible computer-readable media having computer-executable instructions for performing a method by running a software program on a computer, the computer operating under an operating system, the method including issuing instructions from the software program to perform a series of steps comprising:
creating a meeting series within the software program;
assigning a plurality of users to the meeting series;
creating a first meeting;
linking the first meeting to the meeting series;
creating a first plurality of task objects associated with the first meeting, each task object linked to at least one of the plurality of users assigned to the meeting series;
granting permission to view the first plurality of task objects to the users linked to at least one of the first plurality of task objects;
creating a second meeting;
linking the second meeting to the meeting series;
creating a second plurality of task objects linked to the second meeting, each task object linked to at least one of the plurality of users assigned to the meeting series;
granting permission to view the second plurality of task objects to the users linked to at least one of the second plurality of task objects;
creating a meeting series task list listing the first and the second plurality of task objects;
responsive to a first user request to view the meeting series task list, filtering the task list based upon the first user permissions; and
outputting the filtered list to the first user.

11. The media of claim 1, further comprising the steps of:
creating a third meeting;
linking the third meeting to the meeting series;
automatically prepopulating a user list for the third meeting with names of the user assigned to the meeting series; and
electronically sending a meeting invitation to each confirmed user.

12. The media of claim 1, further comprising the steps of:
detecting a status of the first and the second plurality of task objects; and
responsive to detection of a change in the status, automatically updating the task list to indicate a new status.

13. The media of claim 4, wherein the status is selected from the group consisting of completed, pending, overdue, postponed, rescheduled, reassigned, and a combination thereof.

14. The media of claim 1, further comprising the steps of:
detecting a third plurality of task objects with a predetermined status within the first or the second plurality of task objects;
responsive to detecting the third plurality of task objects, automatically creating a third meeting within the meeting series;
associating the third plurality of task objects with the third meeting; and
electronically sending a meeting invitation to each user linked to at least one of the third plurality of task objects.

15. The media of claim 1, further comprising the steps of:
determining a status of each of the first plurality of task objects, and responsive to determining that all of the plurality of the first task objects have been completed, cancelling the first meeting.
